(19) United States
(12) Patent Application Publication
(10) Pub. No.: US 2018/0365608 A1
(43) Pub. Date: Dec. 20, 2018

(54) QUANTITIVE TIME ESTIMATION SYSTEMS AND METHODS OF PROJECT MANAGEMENT SYSTEMS

(71) Applicant: WISETECH GLOBAL LIMITED, Alexandria, New South Wales (AU)

(72) Inventor: James Richard Powell, Alexandria, New South Wales (AU)

(21) Appl. No.: 15/775,682

(22) PCT Filed: Nov. 14, 2016
(86) PCT No.: PCT/AU2016/051093

§ 371 Date: May 11, 2018

(30) Foreign Application Priority Data
Nov. 12, 2015 (AU) 2015904676

(51) Int. Cl. G06Q 10/06

(52) U.S. Cl. CPC G06Q 10/0633

(57) ABSTRACT

Disclosed is a management workflow system product including methods and systems for configuring and utilising acceptability bands and in one embodiment, utilising acceptability bands to release certain work items into a workflow buffer. Disclosed is generating as output one of the plurality of quantifiable values of an acceptability band for the set of workflow items as a measure of the acceptability of the set of workflow items. For particular workflow management variants that are exhibited in workflow items of a set of workflow items, by determining a set attribute score, that score is compared to the acceptability band wherein predetermined acceptability and diminishing acceptability relative to the predetermined acceptability are determined as one or more quantifiable values for the set of workflow items. Workflow management variants can include time estimates established by utilising an x-factor. Acceptability band values can be provided visually or may be utilised in the system background.

### CROSS-REFERENCE TO RELATED APPLICATIONS

The present application claims priority from Australian Provisional Patent Application No 2015904676 filed on 12 Nov. 2015, the content of which is incorporated herein by reference.

### TECHNICAL FIELD

Disclosed are systems and methods for assessing a measure of acceptability for sets of workflow items, where the assessment is based on the composition of a set of a plurality of workflow items.

### BACKGROUND

Workflow management systems aim to improve efficiency in an organisation using defined workflows for different jobs and processes. Workflow management systems can be software systems that help define, administer and coordinate business processes. Such systems enable automation of notification of task allocation to individuals and monitoring work progress to ensure tasks are followed up. Some workflow management systems may automatically allocate tasks for execution. However, methodologies applied for automating allocation of tasks from a task queue tend to be simple, for example First in First out (FIFO), deadline based or following schedule defined manually by a project or business manager.

Most workflow management systems utilise a high degree of project or business manager input for scheduling as the manager can instinctively reorganise work allocations to address potential bottlenecks or balance workloads across different department and employees and modify scheduling or task allocation to address these potential problems. Managers can act flexibly to address the problem. However, automated task allocation in a workflow management system is typically based on defined rules and specific inputs. For example, this may result in the system continuing to allocate tasks to an already overloaded resource or team. In such a situation, instead of efficiency, productivity wanes. An automated system may be able to provide an indication of a bottleneck or other issue occurring but human intervention is typically required to address the problem, for example to manually reallocate tasks or modify allocation rules/criteria.

In principle, workflow management may be possible without the use of computer systems, such as the Kanban system. However, the use of computer systems allow a more sophisticated calculation of parameters, which leads to a better utilisation of resources than what would be possible with non-computerised workflow management.

### SUMMARY

Productivity in private and public entities is of critical importance, and in some cases, to the survival of an entity in harsh business climates and/or to the overall gross domestic product (GDP) of a town, city, state or country. It cannot be overstated that productivity is a substantial component of innovation and evolving business paradigms. Productivity is directly related to the management of workflow. As mentioned above, entities utilise workflow management system products, many of which operate in conjunction with one or more computers. A management workflow system is a product that can be either sold as a standalone product or can be sold as a software as a service (SAS) or otherwise. Disclosed is a product including acceptability bands that can enable the release of work to resources (human or otherwise) in a way that avoids bottlenecks at the outset and can provide a workflow situation where the resources are able take up and complete tasks in a way that avoids over allocation and encumbering other resources.

Disclosed are methods and systems for configuring and utilising acceptability bands in a product that is a management workflow system. Such a product is utilised in different private and public entities to manage resources, in particular, human resources that are performing tasks. While this description involves a software development management workflow system, any system in which resources are utilised is within the scope of this discussion and some are mentioned herein. In furtherance of that end, also disclosed are systems and methods processing workflow items utilising acceptability bands to determine whether to release certain work items into a workflow buffer. Also disclosed are systems and methods for visualising acceptability bands as display output and/or utilising the acceptability bands without visualising them as display output.

More particularly, disclosed are workflow management methods and systems carried out on one or more computers for determining a measure of acceptability based upon one or more particular workflow management variants that are exhibited in workflow items of a set of workflow to determine a set attribute score corresponding to an acceptability band, including receiving input of workflow management variant values of the workflow items of the set of workflow items, the workflow management variant values providing at least one of a quantitative and qualitative evaluation indicative of one or more workflow management variants exhibited in the workflow items wherein workflow management variant values include quantitative time estimates, determining the quantity of workflow items of the set of workflow items that satisfy one or more subset criteria, the subset criteria providing filtering values for filtering the workflow items, the subset criteria being based upon one or more workflow management variant values, and generating based on the workflow items that satisfy the subset criteria the set attribute score for the set of workflow items. Moreover, disclosed is comparing the set attribute score to the acceptability band wherein predetermined acceptability and diminishing acceptability relative to the predetermined acceptability are determined as a plurality of quantifiable values for the set of workflow items and from the comparison, generating as output one of the plurality of quantifiable values for the set of workflow items as a measure of the acceptability of the set of workflow items, determining based at least in part upon the measure of the acceptability of the set of workflow items to release one or more workflow items to a workflow buffer of a resource and delivering to the resource the workflow items of the workflow buffer. Also disclosed is that generating the set attribute score comprises aggregating the quantity of workflow items that satisfy the subset criteria. The quantitative time estimates may be established according to input of a responsible person of a low end time value estimate and an x-factor which is a multiplier value of the first time estimate value.

Also disclosed are methods and systems that include other workflow management variant values, not necessarily time estimates that are utilised in the disclosed workflow management systems products. Also disclosed are methods and systems for configuring an acceptability band, including determining at least one workflow management variant that is exhibited in a set of workflow items, providing a criteria filter based upon one or more criterion to be applied to the set of workflow items to determine a set attribute score based upon a subset of workflow items that satisfy criteria of the criteria filter, establishing an acceptability band having acceptability levels to measure acceptability based upon one or more particular workflow management variants that are exhibited in workflow items of the set of workflow items to correspond to the set attribute score and establishing a correlation of the set attribute score to one or more levels of the acceptability band to provide output of the acceptability band.

Also disclosed is a collective attribute assessment system for quantitatively assessing the collective qualities of a set of items, the system comprising a data store and a processor, the data store storing for the set of items a plurality of subset criteria such that the membership of a subset can be determined for each item in the set and the plurality of memberships thereby determined for each item in the set, the data store also storing a plurality of attributes of the items, item attributes, which are used to determine subset membership, the data store also storing for the set of items a plurality of attributes of the set of items, set attributes, and for each set attribute an acceptability band for the set attribute whereby preferred acceptability and diminishing acceptability relative to the preferred acceptability can be determined as a plurality of a quantifiable values for the set attribute, the data store also storing which quantitative item attribute will be aggregated into a quantitative set attribute, and also storing which aggregation function such as count, sum, mean, median, mode, standard deviation, variance or any other statistical aggregate function is to be used to generate a score of the subset which will be compared with the acceptability scale. Further disclosed is that the processor is configured to receive and store in the data store an input set of items, wherein each item in the set exhibits one or more item attributes of the plurality of attributes of the items, for each item in the set, determine its membership of each of the plurality of subsets, for each subset compute the relevant aggregation function to provide an aggregated quantitative set attribute being a score which can be compared with the acceptability scale; for each of the plurality of set attributes, compare the score with the acceptability scale to choose an acceptability value from one of the plurality of a quantifiable values for the acceptability band and output for the set the collective acceptability measures for each attribute of the set as in input to further processing based on the collective acceptability measures for the set or display of the collective acceptability measures of one or more attributes of the set utilising a visualisation methodology.

### BRIEF DESCRIPTION OF DRAWINGS

An example will now be described with reference to:

FIG. 1 is a block diagram of an example of a workflow acceptability assessment system;

FIG. 2 is a flowchart of an example of a workflow acceptability method;

FIG. 3 is a worked example of filtering a set of workflow items based on subset criteria;

FIGS. 4a to 4d provide examples of different acceptability bands;

FIG. 5 is a block diagram of an example of a workflow acceptability system integrated into a workflow management system.

FIGS. 6a-6d depict visually displayed acceptability band values and output, including mouse overs that show values associated with the output;

FIGS. 7a and 7b show screen shots where a component is selected and bands are applied;

FIGS. 8a and 8b show some definitions provided for establishing acceptability bands in the application of the screen shots of FIGS. 7a and 7b;

FIG. 9 is a block diagram of an example of an estimation system for use in a project management or work tracking;

FIG. 10 is a block diagram of an example of a project management and work tracking system including an estimation system;

FIG. 11 is a flow chart of an example of a process for providing a consolidated estimate;

FIG. 12 is an example of a skewed probability distribution;

FIG. 13 depicts empirical data in carrying out the described systems and methods;

FIG. 14 depicts a screen shot of acceptability bands that are utilised in a workflow management system product;

FIG. 15 depicts workflow items subjected to one or more acceptability bands;

FIG. 16 depicts a screen shot of a workflow buffer;

FIG. 17 shows a screenshot with an example definition of an acceptability band.

FIG. 18 illustrates a user interface where a new set of filter strips can be added to the acceptability band.

FIG. 19 illustrates an example where the acceptability band is configured to show the percentage of AIR shipments which have a particular tag applied.

FIG. 20 illustrates how the above acceptability Band can be configured to show as a tile on the “Forwarding Board”.

FIG. 21 shows the result of the setting of FIG. 20.

FIG. 22 shows a team board.

FIG. 23 shows an individual board.

FIG. 24 shows how default values are specified on the acceptability band.

FIG. 25 illustrates how overridden values are specified on the board configuration form.

FIG. 26 shows how one acceptability band is configured to override the pre-configured boundary values.

FIG. 27 illustrates a user interface for configuring the acceptability band section heading.

FIG. 28 shows a heading with Caution status.

### DESCRIPTION OF EMBODIMENTS

Disclosed is a management workflow system product including methods and systems for configuring and utilising acceptability bands and in one embodiment, utilising acceptability bands to release certain work items into a workflow buffer. Disclosed is generating as output one of the plurality of quantifiable values of an acceptability band for the set of workflow items as a measure of the acceptability of the set of workflow items. For particular workflow management variants that are exhibited in workflow items of a set of workflow items, by determining a set attribute score, that score is compared to the acceptability band wherein predetermined acceptability and diminishing acceptability relative to the predetermined acceptability are determined as one or more quantifiable values for the set of workflow items. Workflow management variants, in one embodiment, can include time estimates established by utilising an x-factor. Acceptability band values can be provided visually or may be utilised in the system background.

The disclosed workflow acceptability assessment systems and methods provide a method that is inextricably linked to on a computer. Data representing a set of workflow items are stored in a database which are filtered according to criteria to determine which of the workflow items satisfy the criteria, those that satisfy the criteria being a subset of the workflow items. The set of workflow items then receives a set attribute score which is compared to an acceptability band which is a measure of the acceptability of the set of workflow items. The data can be stored on a SQL server. Data filters, or filter strips which provide criteria can be applied to the data stored at various times, including time intervals.

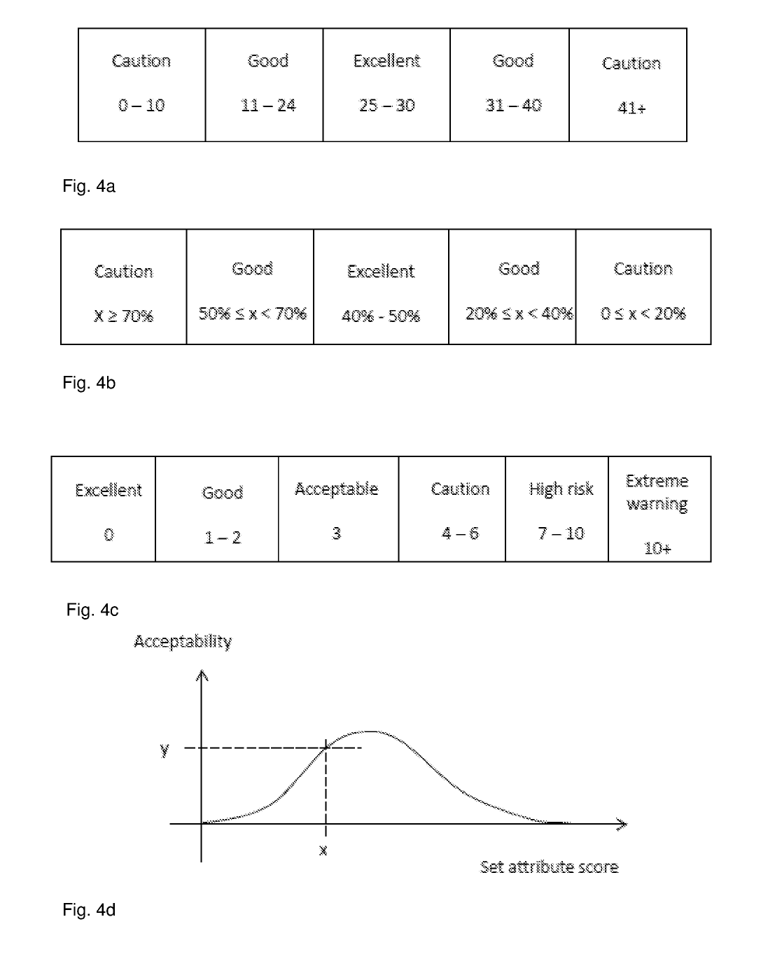

As an example, were the data stored to include workflow management variants such as time estimate values of work items, a filter can be applied to the time estimate values to determine a subset of the work items that satisfy certain criteria. For example, if the criteria were that the time value is one to two hours, and 10% of the work items satisfied that criteria, the 10% can be represented as a set attribute score. The acceptability band may assign values like those of FIG. 4b. Percentage is a form of aggregation which includes any type of aggregation including such as count, sum, mean, median, mode, standard deviation, variance or any other statistical aggregate function is to be used to generate a score of the subset which will be compared with the acceptability scale. Here in this example, the set of work items where 10% has a time value of one to two hours may be flagged as problematic. The mix of the work items could therefore be changed so that time values are instead, for example, three to five hours, so that instead of a set attribute score of 10%, the number is closer to 40%, therefore providing a mix of work items which has a better acceptability. The buffer management system can utilise acceptability bands to determine a mix of work items released into a workflow buffer and therefore move workflow items to a workflow buffer (that is distributed to resources), the buffer often displayed on a workflow display board (such as an electronic board or computer display screen).

When there are thousands or even million work items being generated, in for example, a software development company, keeping the mix of work right for each resource, and/or for each group of resources, can provide for efficiencies. There may be other factors than time, some of which are discussed below, impacting the mix, however, time expected to complete is of course important to, for example, managing handoffs and reviews.

The time estimates for work items can be established by one or more responsible person where input is a low end time value estimate and an x-factor which is a multiplier value of the first time estimate value. High end time value estimates and a divisor as an x-factor is within the scope of this discussion as well. As will be discussed in more detail below, providing time estimates for workflow items would be a step in establishing the workflow item variants of workflow items stored in the database. While time estimates can be made in any suitable manner, the x-factor method of providing time estimates is within the scope of this discussion.

As mentioned above, the disclosed workflow acceptability assessment systems and methods provide a method that is inextricably linked to on a computer. In particularly, acceptability bands can be used to assess the state of a system and provide reports on that state in terms of boundaries (as mentioned above with reference to FIG. 4c.) Acceptability bands, or portions thereof, can be a visibility tool exposed on visual boards such as computer displays. For example, on a display board or computer display screen, a particular component of a workflow item, either a bucket or a buffer component, may have attached to it an acceptability band. Examples of components in the described system are Channel and Chunk, waiting on Prerequisites to Clear, Waiting on Capacity, Capacity Bypass, Waiting on External Prerequisite. As will be shown in more detail below, a window on a computer display screen can be used to configure the acceptability bands for components (of workflow items). Acceptability bands attached to a component can contribute to the overall status of the component regardless of whether they are exposed on the display board.

An acceptability band gives an operator an opportunity to describe a profile of desirability for specified criteria, where the profile of desirability is assessed for a set of items collectively. Any one or more of the items of the set may exhibit the specified criteria but the assessment is based on the set composition, based on the contribution of the items exhibiting the specified criteria in the context of the whole set, rather than considering individual items in the set. The profile of desirability can be defined by an operator based on any applicable criteria, and defines a predetermined acceptability and diminishing acceptability as a plurality of quantifiable values for the set of items.

Considering a set of currently active workflow items in a workflow management system, each of the workflow items will exhibit particular workflow variant values, for example task type, allocated operator, task duration, task cost, customer type, customer location and other workflow item attributes applicable for the workflow items. The workflow management variant values provide at least one of a quantitative and a qualitative evaluation indicative of one or more workflow management variants exhibited in the workflow items. Below are examples of the disclosed methods and systems in first a general example, and then one specific to workflow management variants.

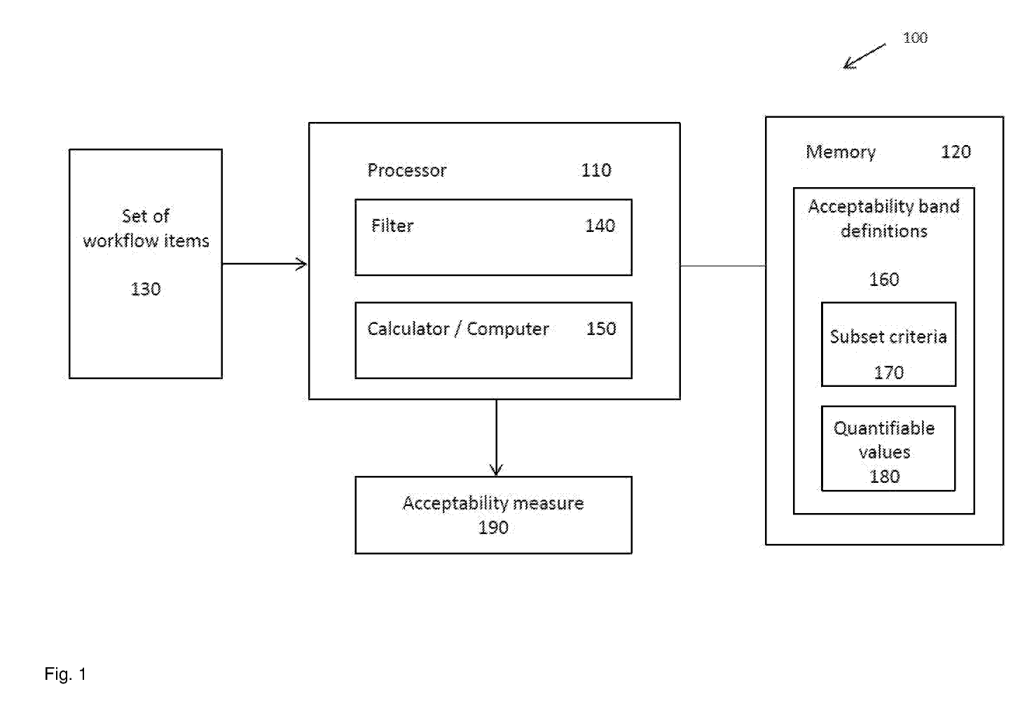

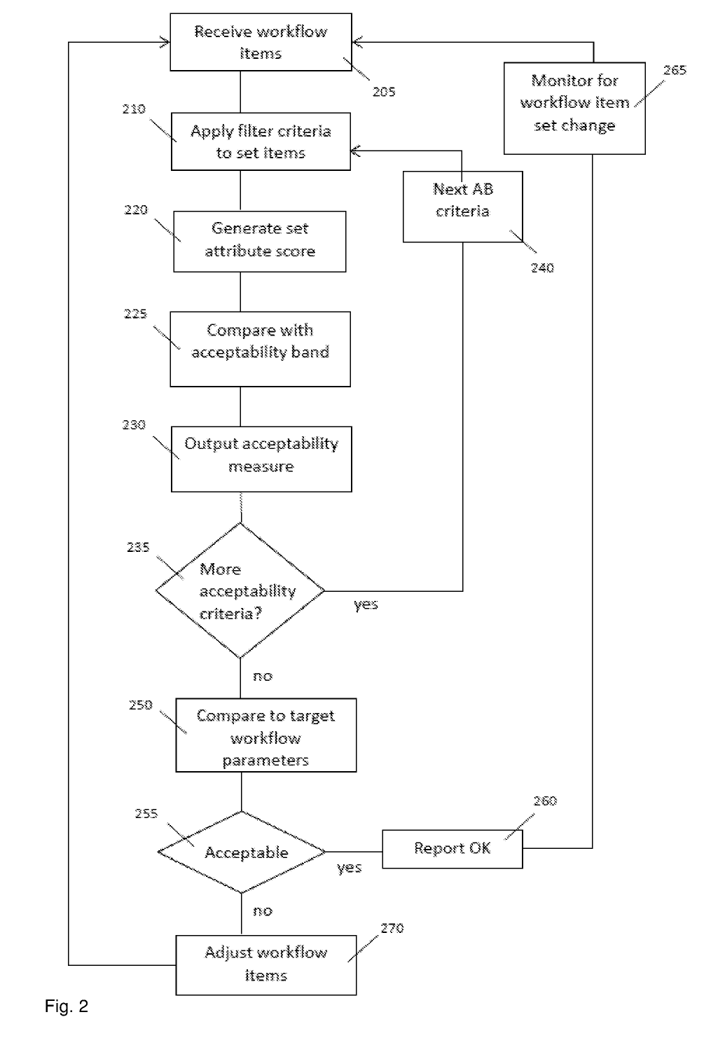

An example of an acceptability assessment system is shown in block diagram form in FIG. 1 and the flowchart of FIG. 2 illustrates an example of the process executed by the system 100. The system 100 is implemented in a computer system comprising a processor 110 and memory 120. Stored in memory 120 is acceptability band definition data 160, including subset criteria 170 and quantifiable vales 180 for one or more acceptability bands. A current set of workflow items 130 may be accessed from a workflow system database or data file accessible to the processor 110. In step 205, the processor 110 receives input of workflow management variant values for the set of current workflow items 130, for example forwarded to the processor in a data signal from a workflow management system or received in response to a query from the processor.

The processor is configured to process the received workflow item data to determine the workflow items that satisfy the subset criteria 170, for example applying a filter 140 to the workflow items 210. In an alternative embodiment the workflow item data is stored in a database and the subset items identified by a database query structured based on the subset criteria to return the workflow items of the set matching the subset/filter criteria, for example an SQL query. In one example, depending on the structure of the query, the data returned may be a count of the number of set items complying with the subset criteria. Alternatively the data returned may be data extracted from the workflow item data of the workflow items complying with the subset criteria, for example task duration data extracted from the workflow item data record of each workflow item complying with the subset selection criteria.

For a set of workflow items, the workflow variant values are used to determine a subset of workflow items that satisfy subset criteria associated with an acceptability band.

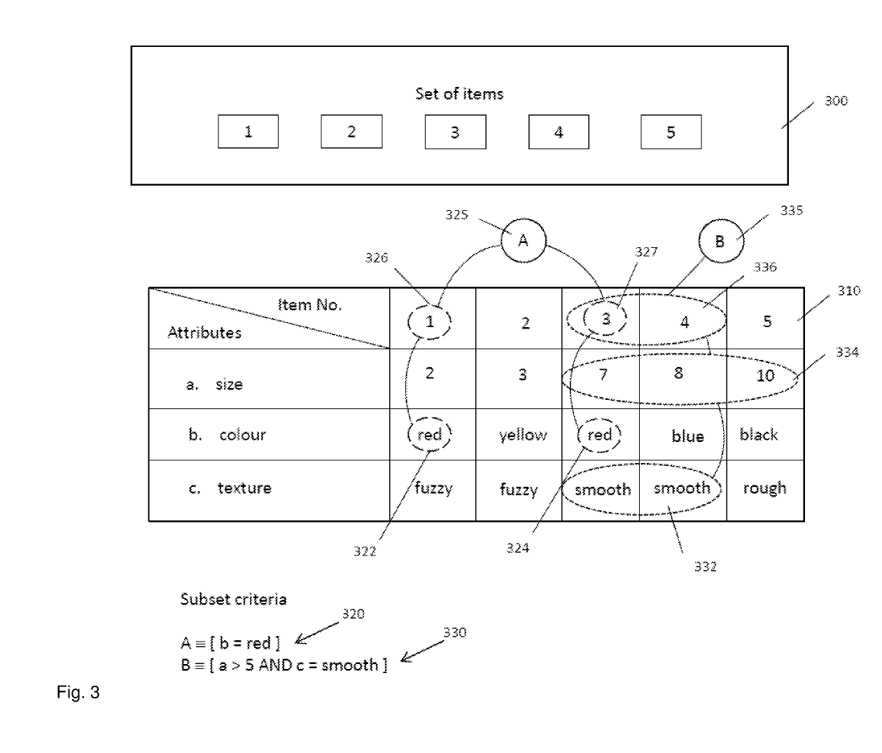

FIG. 3 illustrates a general example of selecting subsets of items based on subset criteria. In the example of FIG. 3 shows a set of five items 300 and a table of item attributes 310. The table 310 shows attribute values of each set item for three attributes:
size
colour
texture.

Subset criteria are defined based on the attributes. The subset criteria 320 for subset A 325 is the colour attribute (attribute b) has the value “red”. From the table 310 the two matches 32, 324 with the attribute b value of “red” occur in the set, therefore items 1 326 and 3 327 are members of subset A 325.

Subset criteria 330 for subset B 335 are the size (attribute a) value is greater than five and the texture attribute (attribute c) has a value of “smooth”. From the table 310 two matches are found for the “smooth” attribute value 332 and three matches are found for size value exceeding five 334. The only items that satisfy both criteria 336 are items 3 and 4 so these two items are members of subset B 335.

In the context of workflow items the item attributes are workflow variants and the attribute values workflow variant values. The same logic for set membership can be applied for a wide variety of different attribute types and combinations.

An acceptability band may define measures of acceptability based on the proportion of the set of workflow items that have the task type, allocated operator, task duration, task cost, customer type, customer location and other workflow item attributes applicable for the workflow items, for example a predetermined acceptability may be 30%, indicating a target for 30% of the workflow items of the set to use, with diminishing acceptability for proportions of workflow items above and below 30%.

Thresholds may be defined within an acceptability band for indicating diminishing acceptability and risk or warnings. For example an acceptability band may be defined having a target value of 30% and a range around 30%, say 25% to 35% as “on target”, “Excellent”, or level 1, ranges of 15% to 25% and 35% to 45% as “near miss”, “good” or level 2, ranges of 5% to 15% and 45% to 55% as “off target”, “caution” or level 3, and ranges below 5% and above 55% as “high risk”, “warning” or level 4.

It should be appreciated that any arbitrary or non-arbitrary value or label may be assigned for a quantifiable value to be returned as an acceptability measure for the set of workflow items. Arbitrary values may be useful to gauge the effectiveness of the range and establish a suitable acceptability measure. The acceptability measures and ranges or acceptability functions will vary between embodiments and implementations. It should be appreciated that the different workflow item attributes can vary greatly between workflow item types and system embodiments. Similarly acceptability band definitions will vary greatly. Acceptability bands may be defined based on subjective opinion of a workflow manager or based on historical assessment of workflow operations, any method of defining acceptability bands is contemplated within the scope of the described systems and methods.

For a returned subset, of workflow items a set attribute score is generated 220 by the processor 110 for each subset. In some embodiments the step 220 of generating the set attribute score comprises aggregating the quantity of workflow items that satisfy the subset criteria, for example, counting of the number of items in the subset. For example, with reference to the example of FIG. 3 the attribute score for attribute b=“red” is two. Aggregation is meant to include any type of aggregation.

Alternatively the step of generating the set attribute score 220 can be based on at least one of the quantitative and qualitative evaluation indicative of one or more workflow management variants exhibited in the workflow items that satisfy the subset criteria. For example the attribute score may be calculated based on the workflow variant values for the subset. The processor may implement a calculator 150 to apply defined calculation rules defined as part of the subset criteria 170. The step of generating the set attribute score 220 may also comprise determining a quantitative value for the workflow items that satisfy the subset criteria relative to the total set. For example, for subset B 335 a set attribute score may be based on a proportion of the set comprising the subset, in the example of FIG. 3, the set attribute score for subset B may be calculated as two fifths of the set, 0.4, or 40%.

The set attribute score for the subset is then compared with the acceptability band defined for the subset 225. The acceptability band may define two or more contiguous ranges for comparison with the set attribute score and each range is associated with one or the plurality of quantifiable values. For example, subset A may have an acceptability band, for “redness” of the set, defined based on count value. This acceptability band may be defined as a of one or less is undesirable, preferred redness is a count of two or three, a count of four is undesirable and a count of five or above highly undesirable. Thus, qualitative values can be assigned to quantitative set attribute values. For subset B of FIG. 3 an acceptability band for “large smoothness” may be defined to deem values below 20% or above 40% as undesirable and acceptable within the range of 20% to 40%. The acceptability band defines a relationship between set attribute values and acceptability. From which predetermined acceptability and diminishing acceptability can be determined for the set of workflow items.

Some acceptability band examples are illustrated in FIGS. 4a to 4d. FIGS. 4a to 4c illustrates acceptability bands having a plurality of contiguous ranges and an acceptability measure associated with each range. In the example of FIG. 4a the acceptability band may be based on a count value or other calculation returning an integer for the set attribute score. In this example a predetermined acceptability of “excellent” is defined for scores within the range of 25 to 30 and diminishing acceptability relative to the predetermined acceptability are defined. In this instance the measure of acceptability diminishes with increasing distance from the target acceptability. In this instance ranges of “good” acceptability are defined for the ranges 11 to 24 and 31 to 40 and further diminishing acceptability of “caution” for the ranges of 0-10 and above 41 or above. For example, such an acceptability band may be applicable for allocation of workflow items to a specified resource and risk management for the resource. In this case the “caution” ranges indicate under and over utilisation respectively, and the good and excellent ranges acceptable and target utilisation respectively. FIG. 4b is an example of an similar acceptability profile to that of FIG. 4a, having a target acceptability bounded by ranges of diminishing acceptability, however in the case of FIG. 4b the ranges are defined based on percentage values. For example, the percentage of time for execution of tasks of a given task type, out of the total execution time for the set of workflow items. In another example, a proportion of workflow items of the set having a specified item type, calculated from subset count compared with total set count. In this example the processor determined with range the calculated value x falls within.

In the examples of FIGS. 4a and 4b the contiguous ranges radiate from a target range representing the predetermined acceptability and the acceptability of each range diminishes based on increasing distance from the target range. The example of FIG. 4c shows an acceptability band where acceptability measures diminish from a target acceptability at one end of the acceptability band range. For example this acceptability band may be applied for assessing defect or errors. In a manufacturing context this may be product defects. In a workflow management contents this may represent workflow item errors, for example handover errors or data entry errors requiring rectification in the currently set of workflow items. In the example of FIG. 4c the target value is zero or no errors, only one or two errors is deemed “good”, three errors acceptable, four to 6 errors “caution”, seven to ten “high risk” and above ten “warning”. As should be apparent the acceptability bands can be useful for defining and determining risks or providing indicators for potential risk within a set of workflow items.

The example of FIG. 4d is an example of a continuous acceptability function where values indicative of varying acceptability y are defined as a function of the acceptability score x. For example, configuring an acceptability band may result in a function which may be based on a defined equation or modelled using historical data and probabilistic analysis. It should be appreciated that acceptability bands are configurable to suit the workflow management environment in which the system is implements and the acceptability band may also be changed or reconfigured in response to changing environments. For example, acceptability bands may be redefined in accordance with business practice changes or in response to changes in conditions, for example in response to financial stress, or seasonal changes.

Again referring to FIG. 2, from the comparison 225, the processor generates as output 230 one of the plurality of quantifiable values for the set of workflow items as a measure of the acceptability of the set of workflow items 190. Where there is more than one acceptability band to evaluate 235, the processor can iteratively assess each band by applying the next subset criteria 240 and repeating steps 210 to 235.

In some implementations the system is configured to compare the output acceptability measures to particular workflow management parameters 250 to determine whether adjustment of the set of workflow items should be made 225. If the determination indicated that no adjustment is required 225, this may be signalled to the workflow management system and optionally output to an operations manager 260. The system can then be configured to monitor for changes to the current workflow item set 265 to trigger automatic repeat of the assessment process, or wait for an external (user or associated system initiated) or internal (periodic) trigger to repeat the assessment process.

As mentioned, tasks can be, for example, of different types of work: projects, defects, paid work, and ordered by the boss. In a computer programming environment, work items may wait for distribution to resources, that is, computer programmers. The work items prior to distribution would be stored, in for example, a database of, for example an SQL server. The following table may represent the filters used on tasks stored in for example a SQL server to release tasks into the workflow buffer from a pre-buffer bucket.

| | Caution | Good | Excellent | | Good | Caution |
|---|---|---|---|---|---|---|
| Type | Min | Min | Min | Excellent | Max | Max |
| Project | 0 | 0 | 0 | 40 | 50 | 60 |
| Defects | 0 | 0 | 0 | 30 | 35 | 40 |
| Paid work | 0 | 0 | 0 | 20 | 30 | 40 |
| Ordered | 0 | 0 | 0 | 3 | 3 | 3 |
| by the Boss | | | | | | |

From these ranges, a mix of work items released to the work buffer can be provided. As mentioned, other ranges may be utilised. It may be a matter of trial and error to determine the optimised ranges.

Acceptability bands can be of different types, the type specifying how the value returned by the conditions is used. The acceptability bands may also provide information about workflow items that may be displayed. In this way, the user interface and display controller can be configured to allow users to monitor their work items and work item progress. The user interface and display controller may also be configured to display acceptability measure data for current workflow items. For example, icons indicative of the status of one or more acceptability bands for the set of current workflow items for a team may be displayed, with the icon indicative of the acceptability measure. For example, colour, image, text/numerals or position of the icon configured to convey information regarding the acceptability measure. For example, the colour green for “excellent”, yellow for “good” and red for “caution”. Alternatively rankings may be used, for example ABCD, 1234 etc. In another example “smileys” or thumbs up/down icons may be used to convey acceptability measures.

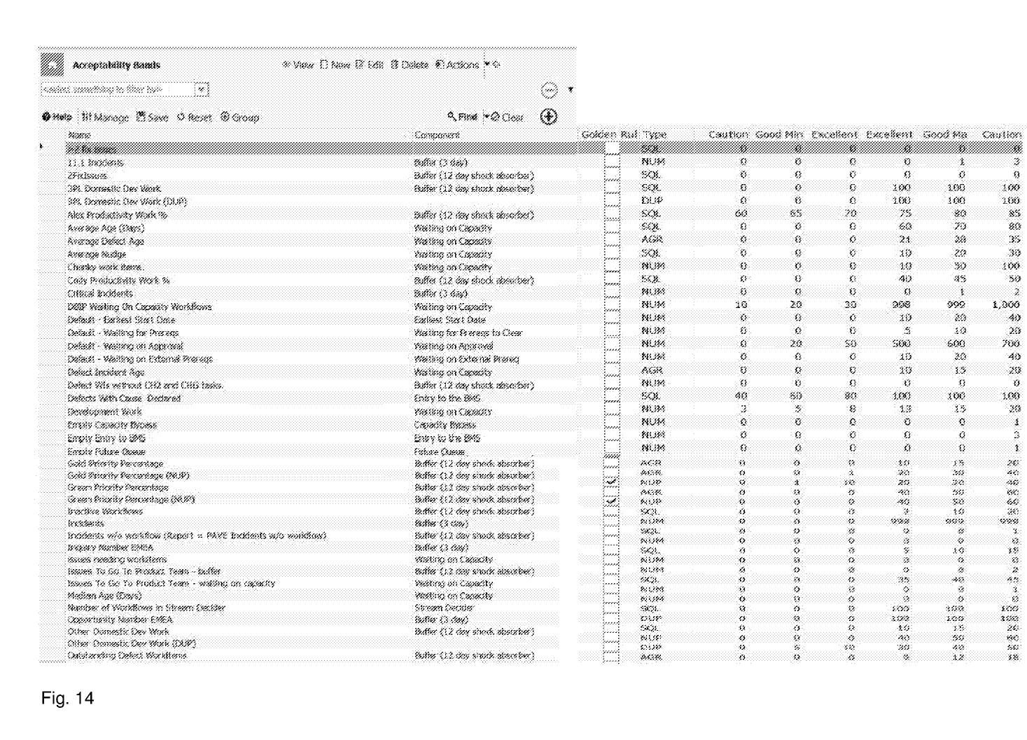

In a work environment, a resource (a software developer) may have a particular function. A new resource may need all work reviewed. A senior resource may be tasked with reviewing work. A display board for example, may be set to show different acceptability bands with reference to particular resource. Examples of acceptability bands that can be used against work items include, for example, pending review, critical incidents. More are discussed with reference to FIG. 14 below. When the acceptability band is applied against work items, the acceptability can be noted and displayed in a manner for example, as described above.

For the pending reviews, the subset criteria that provide filtering values for filtering workflow items, the subset criteria being based upon one or more workflow management variants exhibited in the workflow items, for pending review, can include:

Where the workflow is in the 12 day buffer

And the workflow's release group is in a particular group

And the workflow's name does not contain ‘Quality iteration’

And the workflow is open

And the work to be reviewed is completed

And the review is not completed.

The above-list of subset criteria may include one or more criterion that are functional. That is, the determination of whether the subset criterion is met is a based upon one or more attributes. The subset criterion therefore can be dependent upon other measurable qualities.

Pre-filtering of workflow items may take place to provide a short cut for determining whether the subset criteria being based upon one or more workflow management variants exhibited in the workflow items exists. That is, the prior filtering can determine the measure of acceptability, and the work item can be tagged as such. In this way, the item has been pre-filtered.

Filtering can occur at any suitable time. It may occur when a display board showing work items is refreshed. It may occur at particular intervals, such as thirty minute intervals. Filtering can occur in any suitable manner.

Determining whether or not adjustment of the workflow items should be made 225 can be performed based on one or more of the output measures of acceptability and any further defined criteria. For example, a hierarchy may be defined for different acceptability measures, whereby a determination of adjustment being required may be based on a single acceptability measure. In other examples acceptability measures may be aggregated or combined in accordance with defined rules to provide a collective assessment of the acceptability of the set based on assessments based on a plurality of acceptability bands.

In some disclosed systems and methods a target proportionate mix for two or more measures of acceptability is defined for the set of workflow items. In this example, the processor is further configured to determine the set attribute score and quantifiable value for the set of workflow items for each of the measures of acceptability for the target proportionate mix. Process the set attribute scores and quantifiable values for the measures of acceptability to determine the relative proportional values for the two or more measures of acceptability for the set of workflow items, and compare the relative proportional values with the target proportionate mix for the set of workflow items. The comparison result is the output to trigger adjustment of workflow items 270. The adjustment of workflow items may be performed manually by a project or business manager. For example, manually reallocating workflow items to add and/or remove workflow items to the set. The adjustment of the workflow items may also be performed automatically by a workflow management system. For example, based on difference between the target proportional mix and the current set proportional mix, selecting work items to add or remove from the set based on the biggest difference between the current and target mix.

The desired proportional mix may be defined based on a subset of a set of a plurality of measures of acceptability determinable for the set of workflow items. For example, a desired proportionate mix may be defined based on a workflow variant type. In different industries, workflow variants can be defined to suit the industry. Up until now the discussion has been with regard to software development. However, others including shipping can utilise acceptability bands in much the same way. For example transport mode, which may take on the values of “sea freight”, “air freight” and “land transport”. A target proportionate mix for the set may be defined based on this workflow variant. For example, the target proportionate mix being 40% air freight, 30% sea freight and 30% land transport. The target proportionate mix may correspond to target acceptability assessment values. For example, a proportionate mix for a current set may be 10% air freight, 40% sea freight and 50% land transport. In this instance a set attribute value for air freight of 10% may return a high risk acceptability assessment measure, the 40% value for sea freight a good acceptability measure, and 50% land transport a caution acceptability measure. In this instance the workflow variant values giving rise to low acceptability are also workflow variant values showing the biggest deviation from the target mix. However, if the acceptability band is based on a workflow variant value that is not calculated proportional to the set, for example a revenue measure the comparison between acceptability measure and proportional mix may be different. For example the 50% of land transport type tasks may have revenue acceptability measure indicating “on target” or “excellent”. Whereas the 40% sea freight type tasks may have revenue acceptability of “adequate” and the 10% air freight have a revenue acceptability of “poor”. In this example of an application of acceptability bands, considering the acceptability measures for revenue and proportionate mix in combination, indicates that the business needs to look at generating and bringing into the current workflow item set more workflow items relating to air freight and sea freight, rather than remove land transport type workflow items.

The workflow management system may trigger a reassessment of the acceptability measures to determine whether the adjustment has made a comparatively positive or negative impact. It should be appreciated that set adjustment and recalculation can be repeated iteratively until the target proportionate mix is achieved or other end criteria have been met. For example, a percentage improvement, a set number of iterations, diminishing improvement, maximum options tried, etc.

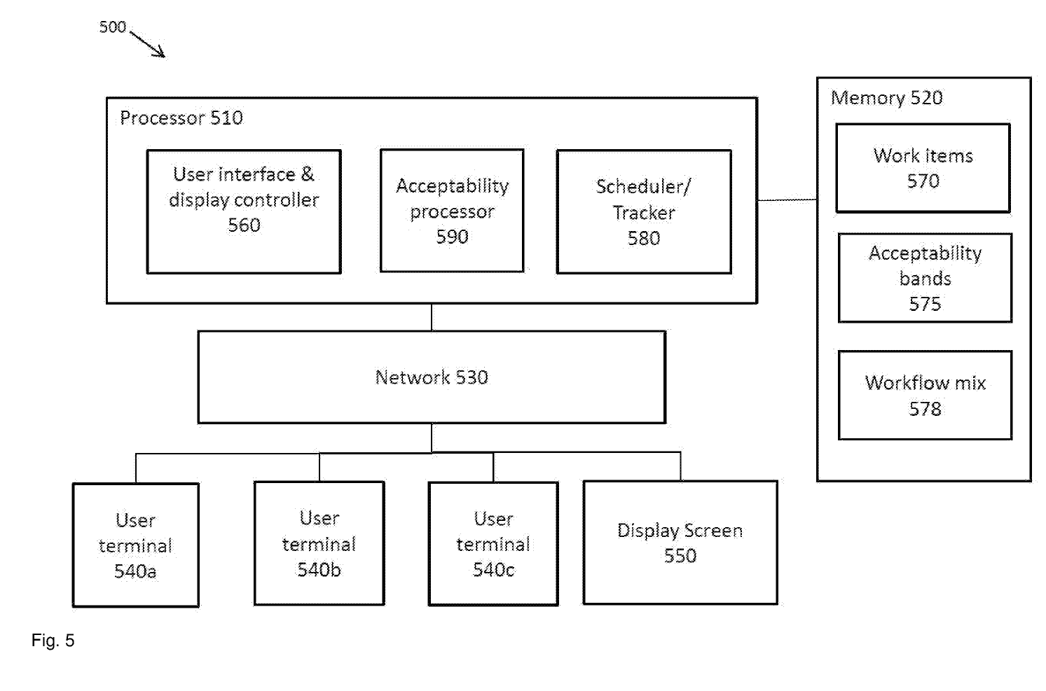

The disclosed systems and methods can be utilised as an component of a work scheduling and tracking system or as a standalone workflow assessment system. An example of a work scheduling and tracking system incorporating an embodiment of the estimation method is illustrated in FIG. 5. The work scheduling and tracking system is implemented in a computer system environment comprising processor 510 resources and memory 520 resources used to implement program system functionality including scheduling of workflow items and tracking execution by a scheduler/tracker 580 using defined work item data 570 and managing acquisition and dissemination of work item data from users by a user interface and display controller 560.

Work item data 570 for a plurality of work items is stored in memory 520, for example as one or more data files or in a database structure. The scheduler/tracker 580 is configured to enable work item data to be entered into the system, for example based on project task definition, customer orders etc., for execution and tracking. The scheduler/tracker may provide tools to facilitate work item definition and scheduling. The scheduler/tracker may facilitate work item definition and storage in a work item definition storage location of a database. Data elements representative of each of the work items can be separately stored in data fields defined in the database, the data representing each work item can include an identifier data element which can be used to render for display information to allow a user to identify the work item and work item variant data fields for storing work item variant values. The work item variant values may be stored based on input data or in response to workflow item scheduling and execution. The scheduler/tracker may include functionality for automated monitoring and update of work item execution data. For example, managers and team leaders may input initial work item definitions and initial data, the data for these work items can be subsequently updated manually or automatically based on activity of project team members, for example in response to deliverable being completed or periodic status updates of work progress input form user terminals and updated in the system memory 520. The user interface and display controller 560 is configured to control display of project information to users, (for example, via their user terminals 540a-c or common resources such as a project tracking display screen 550), outputting of reports, and receipt of input data from users, for example from networked user terminals 540a-c. For example, the user interface and display controller 560 may be configured to control presentation of a display screen displaying workflow items identification data and data for workflow items allocated to a user for execution. This may include display of graphical user interfaces to assist input of data values, for example displaying duration selection sliders, date selectors etc. manipulable by a user to graphically indicate a numerical value, for example, number of person minutes or hours, calendar based estimates etc. to input data for a workflow item.

The user interface and display controller may also be configured to perform data transformation of input data from a file input into alternative file formats or database entries. For example, conversion of a data input in a spreadsheet format to database data entries. Input format conversion may also convert input data from input formats incompatible with other system components into compatible formats. Alternatively an input interface and display controller embodiment may be configured to perform data extraction or data mining to automatically identify project relevant data from monitored inputs or associated systems, for example data mining from change requests, and extraction of project relevant time entries from a timekeeping system. It should be appreciated that the above described examples of project management and work tracking functionality is non-limiting and the different functions implemented by the project management and work tracking system will vary between embodiments and different functions can be implemented to tailor the system for different project environments. The acceptability processor 590 is configured to retrieve workflow variant value data for a set of workflow items from the work item data 570 stored in memory 520 and perform acceptability assessment utilising defined acceptability band data 575 as described above with reference to FIG. 2. The system 500 may also be configured to allow users to define acceptability bands. For example, the user interface and display controller may be configured to display data entry screens to facilitate definition of subset or filter criteria for an acceptability band and define the acceptability measures and associated ranges and functions. This may also include defining set attribute calculation criteria. The data entry screens may also be configured to facilitate re-configuring or re-defining acceptability bands. Data entry screens can also be provided to allow definition of one or more desired proportionate mix of workflow variants for a set of workflow items.

The system can be implemented using a variety of different system architectures. For example, in an embodiment the processor 510 and memory 520 resources may be provided by a general purpose computer such as a personal computer (PC), laptop/tablet computer, or server having internal memory including volatile (for example, random access memory RAM, buffers etc.) and non-volatile (hard disk, solid state memory, optical disk etc.) memory resources and optionally external memory resources accessible by the processor via wired or wireless data connections. In alternative embodiments the processor 510 and memory 520 resources may be network accessible distributed resources, for example distributed processing and memory resources within a company network, or “cloud based” on demand processing a memory resources accessible via the internet.

In this example the work scheduling and tracking system processing 510 and memory 520 resources are in data communication with user terminals 540a-c and other communication resources such as display screens via a network 530. For example, the network 530 may be a local area network, such as an Ethernet network or secure WiFi within a company premises, or a secure intranet. Alternatively, the network may be a public network such as a telecommunication network or the Internet. The user terminals 540a-c may be laptop or desktop computers, tablets or smart phones etc., having input interfaces such as keyboards, touch screens, scanners, transceivers, microphones and sensors (for example, sensors for motion, speed, temperature, humidity, light, location etc.). Output interfaces can include display screens, speakers, printers etc. The types of input and output devices provides at a user terminal can vary between users terminals and many variation of terminals can be supported by any one system embodiment.

The system functionality is implemented in some embodiments as one or more software programs which execute using the processing 510 and memory 520 resources as described above and interact with external interfaces of the networked computers 540a-c. The system may be implemented as software programs or routines executable using the processing 510 and memory 520 resources which are accessible via a network 530 from one or more user terminals which provide user interface capability and local processing capability and memory. In alternative embodiments some system functionality may be implemented using a combination of hardware and software. For example, the network 530 may be a local area network, such as an Ethernet network within a company premises, or a secure intranet. Different users may be enabled access to the system for specific purposes only. For example, some employees or job categories may be provided with access to view a broad range of data but limited to updating only defined data elements, typically related to work defined for the user. Other users, such as project managers and team leaders may be provided access to enable viewing and updating of broader ranges of data. In some embodiments, updating of some categories of data may be restricted to ensure that only the user to whom work is allocated or an authorised delegate may update the data relating to the work.

The acceptability processor may be configured to automatically assess and output workflow item set acceptability measures based on system triggers, for example periodically or in response to actions, such as removal of workflow items from a current operating set in response to workflow item completion and addition of workflow items to the current operating set. For example, in response to automatic work scheduling by the scheduler 580 or manual allocation by a manager. In some embodiments the acceptability processor may be configured to assess acceptability measures for a nominal set of work items. For example, a nominal set of work items may be defined for hypothetical work item reallocation/rescheduling scenarios either by a project or business manager or generated by the system. The disclosed embodiments may be implemented as a component of a project management system or as a stand-alone system.

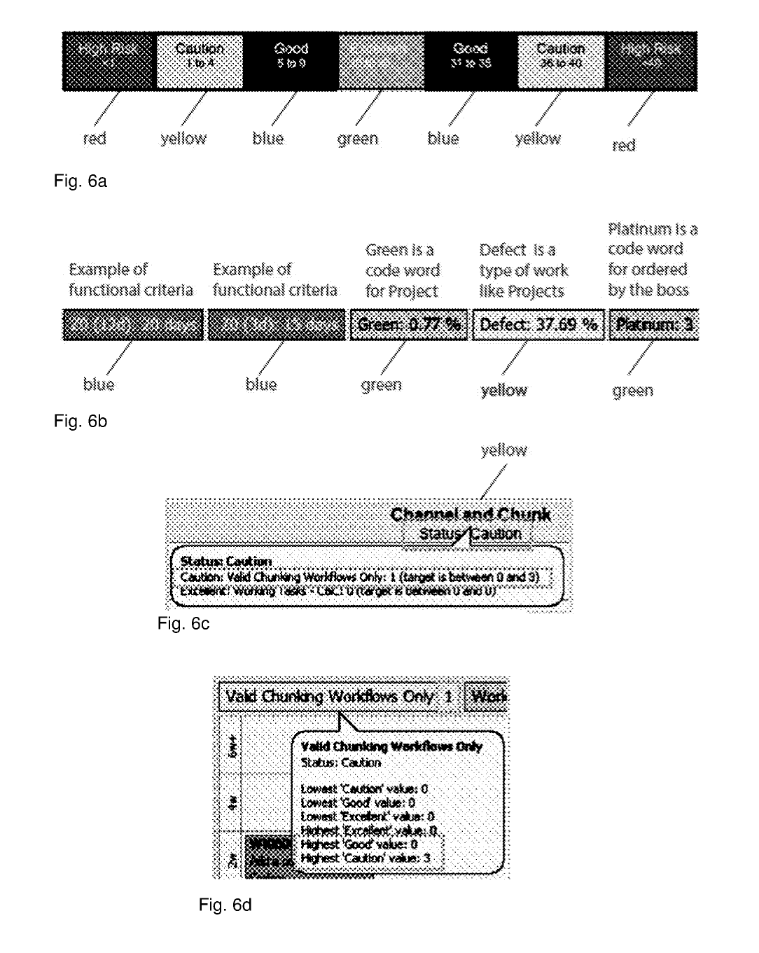

As mentioned above, the acceptability band can be a visual tool. FIG. 6a shows how an acceptability band can be visually depicted in, for example, colours. FIG. 6b shows, for example, looking at Green: 0.77% which is a code word for “project” (see above), the fact that it is at 77% says that in the acceptability band that which applies a criteria filter to one or more components of the “project” work items, that 77% is within the excellent range, and that can be determined by the colour associated with it, which is green. Any other form of visualisation is within the scope of this discussion.

FIG. 6c depicts that a component “Chunk and Channel” is yellow which according to FIG. 6a, means caution. On a display board, a feature can include the ability to mouse over the visualised acceptability band to see what the criteria for the acceptability band is that has been applied. FIG. 6d further shows that a mouse over may reveal the acceptability band itself.

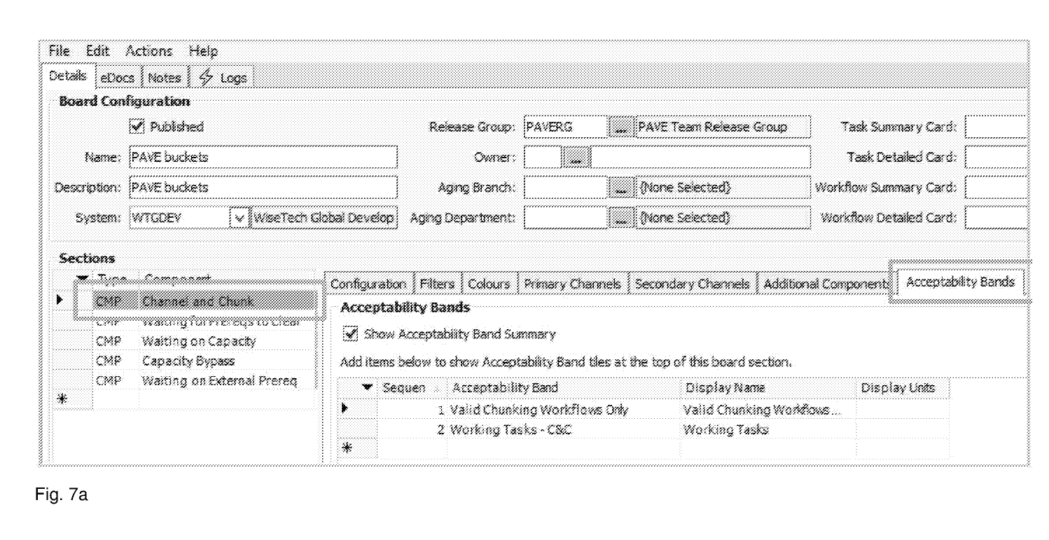

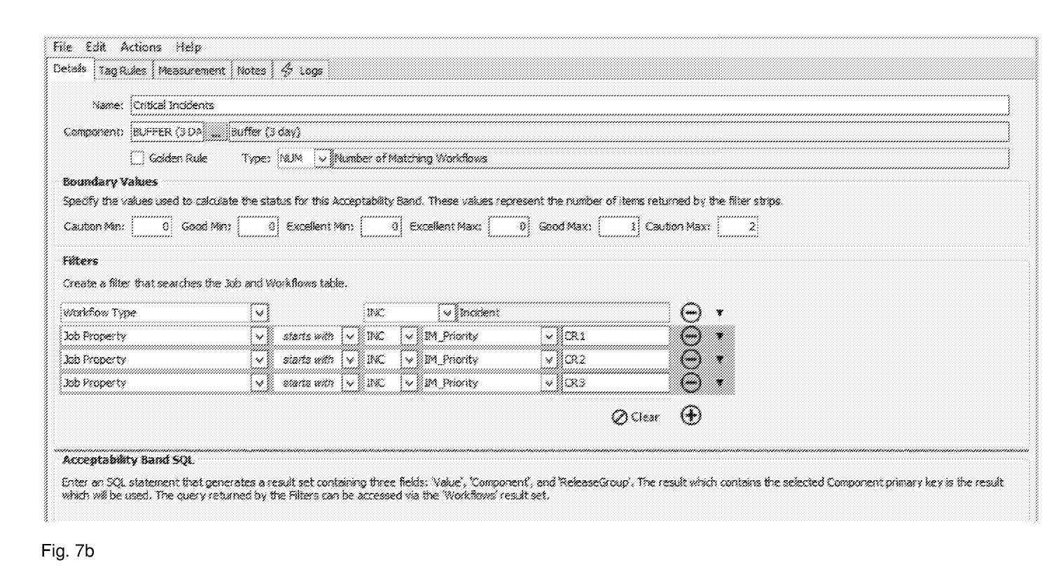

FIG. 7a depicts an acceptability band configuration screen. FIG. 7b depicts a filter configuration screen for the acceptability band configuration. FIG. 7a depicts that a component is selected, in this case “channel and chunk” and aspects of the acceptability band is depicted. In the next screen, FIG. 7b, boundary values can be provided.

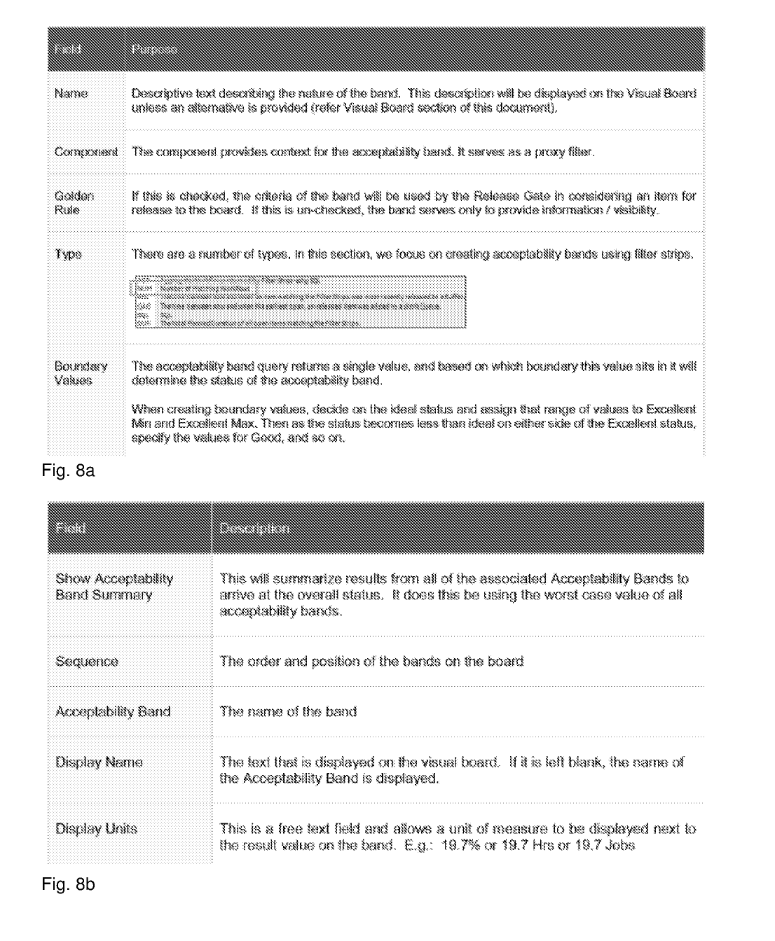

FIGS. 8a and 8b depict instructions and definitions for the configuration screens. It is understood that any manner in which to define an acceptability band is within the scope of this discussion. Criteria in the form of filters such as those shown in FIG. 3 can be applied. Above, a plurality of criteria for pending reviews, was described. As mentioned, one or more criterion can be functional. That is, the determination of whether the subset criterion is met can be based upon one or more attributes. The subset criterion therefore can be dependent upon other measurable qualities. Time estimates is an example of a criteria (filter strip) that can be utilised as criteria in acceptability bands.

Many methodologies and systems exist for resource estimation in project planning and some systems can be quite effective where resource requirements can be well defined and predictable. For example, where processes are mechanical, routine repetitive tasks such as laying carpet per square metre, or consumption of resources where historical data allows relatively accurate estimation, such as time for consumption of a tank of fuel during average city driving. Reasonably reliable estimates, particularly time estimates, can be produced using historical data for repetitive or routine tasks.

Estimation of effort (typically measured in time or value based on time estimates) for professional services presents a much more difficult problem due to the nature of the work. For example, in research and development work in a project is often new. A new problem to solve or set of requirements to implement may have no accurate historical body of data from which to infer estimates exists. Further, the execution of the work is highly dependent on the individuals performing the work. This can include individual competence and efficiency, available working hours, task loading and other external factors. Other external factors may include personal problems which may impact on work performance, for example, health or family problems, or work related impacts such as office politics or performance perceptions. All of these factors which may influence the individual performing the work can be highly variable and individualised.

Some known approaches to try to improve estimation accuracy in highly variable environments include detailed definition of work components and estimating based on each narrowly defined component. Project planners start drilling into the task durations attempting to fix the estimation problem, based on the theory that finer granularity enables more accurate prediction—i.e. the more we know, the more accurate the estimate. This approach may be effective if one were dealing with something that is highly predictable or based on historical data, for example when measuring how long it would take for a tank of petrol to be consumed with average city drivers. In this case, one can obtain a distribution to use for estimation from experimental or historical data. However, finer granularity of estimation may not solve the problem, particularly for professional services. Some narrowly defined tasks may be more accurately estimated but others still suffer from high variability as discussed above.

Some known systems aim to solve estimation problems using various statistical methodologies, involving estimating standard deviations around the means. For example, an estimate of five hours being interpreted as a mean of five hours and a probability distribution existing around that mean estimate, typically assuming a normal “bell” curve distribution. Many methods involve some number that is deemed to be a mean, and then some other numbers that are standard deviations. Such systems typically use a three or four point estimation technique, for requiring estimators to try to accurately predict three of four different values for a task—for example, mean, median, mode, standard deviation—giving an estimate of variability about likely/expected outcomes. Several problems with existing statistical estimation methods have been noted when these are applied for estimation of professional services.

First, many methods assume a normal distributions for probability for the outcome, however the probability distributions tend to be skewed. Typically, a time estimate for a body of work has a much higher chance of being longer than a most likely estimate than it has of being shorter than the most likely estimate. Thus, any method based on a standard distribution is flawed, and in reality losses will accumulate and gains are lost.

Second, significant consideration and/or calculation is required for the estimator to derive the three or four point estimation data. However, due to the nature of the work this calculation requires many assumptions—so the estimates may have been estimated using incorrect assumed values and therefore be inaccurate. There is a reluctance to provide such estimates due to the effort and once an estimate is given, pressure to commit to generating the outcome “on time” at the maximal likelihood estimate given.

Third, estimates tend to be optimistic or pessimistic, this may also be influenced by external human factors, such as a project manager putting pressure on staff to provide shorter time/lower cost estimates. When making a consolidated estimate, an over representation of under or over estimators can significantly influence the outcome.

Another problem is network effects whereby some tasks are executed serially but others may be executed in parallel. Estimates in this case are not all additive, serial tasks are additive but others are not. This means additional data is required to enable network effects to be taken into consideration for a consolidated estimate encompassing several tasks. The effort required to model network effects to enable accurate compensation for network effects in estimates is typically not performed and therefore the mathematics used for calculating consolidated estimates is typically flawed. Historical data may be used to regressively determine an empirical value to use for compensation of network effects, but this will only be effective if the amount of parallel and serialism is relatively constant between projects.

Typically the result of these estimation methods and problems is erroneous estimations which can be misleading, when used in project planning management and tracking systems and induce frustration and lack of confidence. There is a need for a more effective estimation system for estimation of effort for integration into project management and tracking systems.

Also disclosed are quantitative time estimation methods and systems of a project management system. Utilising a display driver and a processor, methods include rendering for display a sub-task identifier and one or more user input fields for a sub-task representing high confidence assessment of a first time estimate value and a high confidence assessment of a second time estimate value for the sub-task. The second time estimate value is a multiplier or divisor value representing high confidence assessment of variability from the first time estimate value. The disclosed method further includes from user input, the processor generating an associated centre value derived from two of the low end time value, the high end time value and the range width value and the processor aggregating the associated centre value for each sub-task of a task to generate a consolidated quantitative time estimate for the task for utilisation in the project management system.

In a disclosed quantitative time estimation system, the system can include a display driver, a processor and a database. The database can be for storing in a task definition storage location of the database task data representative of one or more defined tasks and wherein each task comprises a plurality of sub-tasks, wherein data elements representative of each of the sub-tasks are separately stored in data fields defined in the database, the data representing each-sub task including a sub-task identifier data element. The display driver can be configured to generate for display on a display screen, a user interface displaying at least one sub-task identifier and provide input fields to input a first time estimate value and a second time estimate value for the sub-task, wherein the first time estimate value is a quantitative value representing high confidence assessment of one end of a time estimate range, and the second time estimate value is a quantitative value representing high confidence assessment of the other end of the time estimate range. The processor can be configured to, in response to receiving data input of the first time estimate value and the second time estimate value, determine using the first time estimate value and the second time estimate value for the sub-task, a low end time value, a high end time value, and a range width value and store the low end time value, high end time value, and range width value as data elements for the sub-task in data fields defined in the database, generate for the sub-task an associated centre value derived from the low end time value and the high end time value and store the associated centre value as a data element for the subtask in a data field defined in the database. The processor can be further configured to provide output representative that an associated centre value has been stored for all sub-tasks of a task and aggregate the associated centre value for each sub-task of a task to determine the consolidated quantitative time estimate for the task. The processor can be further configured to output the consolidated quantitative time estimate for the task for utilisation in a project management system.

The disclosed project management systems and methods include a data base for storing in a task definition storage location, task data representative of one or more defined tasks and wherein each task includes a plurality of sub-tasks. Data elements representative of each of the sub-tasks are separately stored in data fields defined in the database, the data representing each-sub task including a sub-task identifier data element. A processor can be in data communication with the database, the processor configured to automatically update task and sub-task data stored in the database in response to receiving data input indicative of task planning and execution. A display driver can be configured to generate and display on a display screen, a user interface to enable data input to define tasks and sub-task in the task definition storage location of the database, wherein for a project planning phase the display driver can be configured to generate for display on a display screen, a user interface displaying at least one sub-task identifier and providing input fields to input a first time estimate value and a second time estimate value for the sub-task, wherein the first time estimate value is a quantitative value representing high confidence assessment of one end of a time estimate range, and the second time estimate value is a quantitative value representing high confidence assessment of the other end of the time estimate range. The processor can be configured to, in response to receiving data input of the first time estimate value and the second time estimate value, determine using the first time estimate value and the second time estimate value for the sub-task, a low end time value, a high end time value, a range width value and store the low end time value, high end time value, and range value as data elements for the sub-task in data fields defined in the database. The process can furthermore be configured to generate for the sub-task an associated centre value derived from the low end time value and the high end time value and store the associated centre value as a data element for the subtask in a data field defined in the database. The processor can be also configured to provide output representative that an associated centre value has been stored for all sub-tasks of a task, aggregate the associated centre value for each sub-task of a task to determine the consolidated quantitative time estimate for the task, store the consolidated quantitative time estimate. The processor can be further configured to apply the consolidated quantitative time estimate for one or more tasks in an automated task scheduling process.

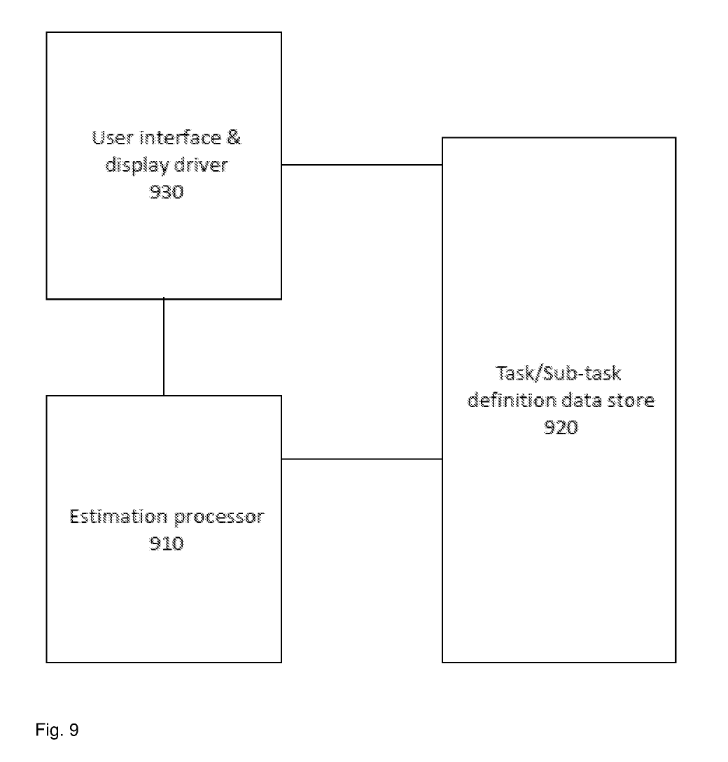

The disclosed systems and methods provide a computer system implemented quantitative estimation method and system enabling generation of a consolidated estimate for a task comprising a plurality of sub-tasks. In a first example, as illustrated in the block diagram of FIG. 9, the system comprises an estimation processor 910 which utilises a task definition 920 data file or database and a user interface and display driver 930 to facilitate communication with user terminals or other input and output devices. The task definition data file or database 920 stores data for one or more tasks broken down into sub-tasks. The estimation processor 910 is configured to, for each task, trigger the user interface and display driver to cause display of sub-task data to users and receive input of a first value and a second value for each subtask. In response to receiving data input of the first and second values, the estimation processor 910 determine an estimated range for the sub-task. From these two values only the estimation processor determines, for a range, a low end estimate, a high end estimate, a range width and a centre value. The estimation processor determines a consolidated estimate by aggregating the centre values calculated for each sub-task from the input values for all the subtasks of a task.

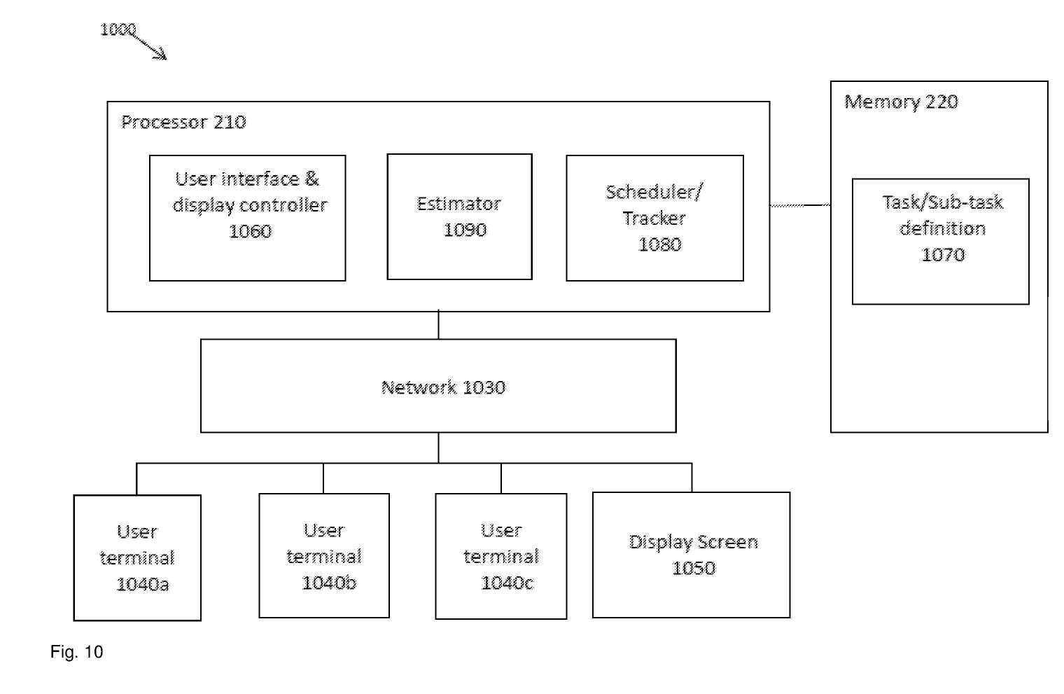

The disclosed systems and methods can be utilised as an component of a project management or work tracking system or as a standalone estimation system. An example of a project management and work tracking system incorporating an embodiment of the estimation method is illustrated in FIG. 10. The project management and work tracking system is implemented in a computer system environment comprising processor 1010 resources and memory 1020 resources used to implement program system functionality including scheduling of tasks/sub-tasks and tracking execution by a scheduler/tracker 1080 using defined task and sub-task data 1070 and managing acquisition and dissemination of project data from users by a user interface and display controller 1060.

Project tasks are broken down into sub tasks and the task/subtask data 1070 stored in memory 1020, for example as one or more data files or in a database structure. The scheduler/tracker 1080 is configured to enable project data to be entered into the system for initial project definition and project execution tracking. The scheduler/tracker may provide tools to facilitate the initial task definition and subtask breakdown from higher level project specifications and requirements, and task/subtask scheduling. The scheduler/tracker may facilitate task and sub-task definition and storage in a task definition storage location of a database task data representative of one or more defined tasks and sub-tasks. Data elements representative of each of the sub-tasks can be separately stored in data fields defined in the database, the data representing each-sub task including a sub-task identifier data element which can be used to render for display information to allow a user to identify the subtask. The scheduler/tracker may include functionality for automated monitoring and update of project execution data. For example, managers and team leaders may input initial project task and subtask definitions and initial data, the data for these subtasks can be subsequently updated manually or automatically based on activity of project team members, for example in response to deliverable being completed or periodic status updates of work progress input form user terminals and updated in the system memory 1020. The user interface and display controller 1060 is configured to control display of project information to users, (for example, via their user terminals 1040a-c or common resources such as a project tracking display screen 1050), outputting of reports, and receipt of input data from users, for example from networked user terminals 1040a-c. For example, the user interface and display controller 1060 may be configured to control presentation of a display screen displaying sub-task identification data and data fields allowing input of estimation values, for example estimation of effort required for completion of a task which will typically be a time based estimate. This may include display of graphical user interfaces to assist input of data values, for example displaying duration selection sliders, date selectors etc. manipulable by a user to graphically indicate a numerical value, for example, number of person minutes or hours, calendar based estimates etc.

The user interface and display controller may also be configured to perform data transformation of input data from a file input into alternative file formats or database entries. For example, conversion of a data input in a spreadsheet format to database data entries. Input format conversion may also convert input data from input formats incompatible with other system components into compatible formats. Alternatively an input interface and display controller embodiment may be configured to perform data extraction or data mining to automatically identify project relevant data from monitored inputs or associated systems, for example data mining from change requests, and extraction of project relevant time entries from a timekeeping system. It should be appreciated that the above described examples of project management and work tracking functionality is non-limiting and the different functions implemented by the project management and work tracking system will vary between embodiments and different functions can be implemented to tailor the system for different project environments.

The system can be implemented using a variety of different system architectures. For example, in an embodiment the processor 1010 and memory 1020 resources may be provided by a general purpose computer such as a personal computer (PC), laptop/tablet computer, or server having internal memory including volatile (for example, random access memory RAM, buffers etc.) and non-volatile (hard disk, solid state memory, optical disk etc.) memory resources and optionally external memory resources accessible by the processor via wired or wireless data connections. In alternative embodiments the processor 1010 and memory 1020 resources may be network accessible distributed resources, for example distributed processing and memory resources within a company network, or “cloud based” on demand processing a memory resources accessible via the internet.

In this example the project management system processing 1010 and memory 1020 resources are in data communication with user terminals 1040a-c and other communication resources such as display screens via a network 1030. For example, the network 1030 may be a local area network, such as an Ethernet network or secure WiFi within a company premises, or a secure intranet. Alternatively, the network may be a public network such as a telecommunication network or the Internet. The user terminals 1040a-c may be laptop or desktop computers, tablets or smart phones etc., having input interfaces such as keyboards, touch screens, scanners, transceivers, microphones and sensors (for example, sensors for motion, speed, temperature, humidity, light, location etc.). Output interfaces can include display screens, speakers, printers etc. The types of input and output devices provides at a user terminal can vary between users terminals and many variation of terminals can be supported by any one system embodiment.

The system functionality is implemented in some embodiments as one or more software programs which execute using the processing 1010 and memory 1020 resources as described above and interact with external interfaces of the networked computers 1040a-c. The system may be implemented as software programs or routines executable using the processing 1010 and memory 1020 resources which are accessible via a network 1030 from one or more user terminals which provide user interface capability and local processing capability and memory. In alternative embodiments some system functionality may be implemented using a combination of hardware and software. For example, the network 1030 may be a local area network, such as an Ethernet network within a company premises, or a secure intranet. Different users may be enabled access to the system for specific purposes only. For example, some employees or job categories may be provided with access to view a broad range of data but limited to updating only defined data elements, typically related to work defined for the user. Other users, such as project managers and team leaders may be provided access to enable viewing and updating of broader ranges of data. In some embodiments, updating of some categories of data may be restricted to ensure that only the user to whom work is allocated or an authorised delegate may update the data relating to the work. The disclosed embodiments may be implemented as a component of a project management system or as a stand-alone system.

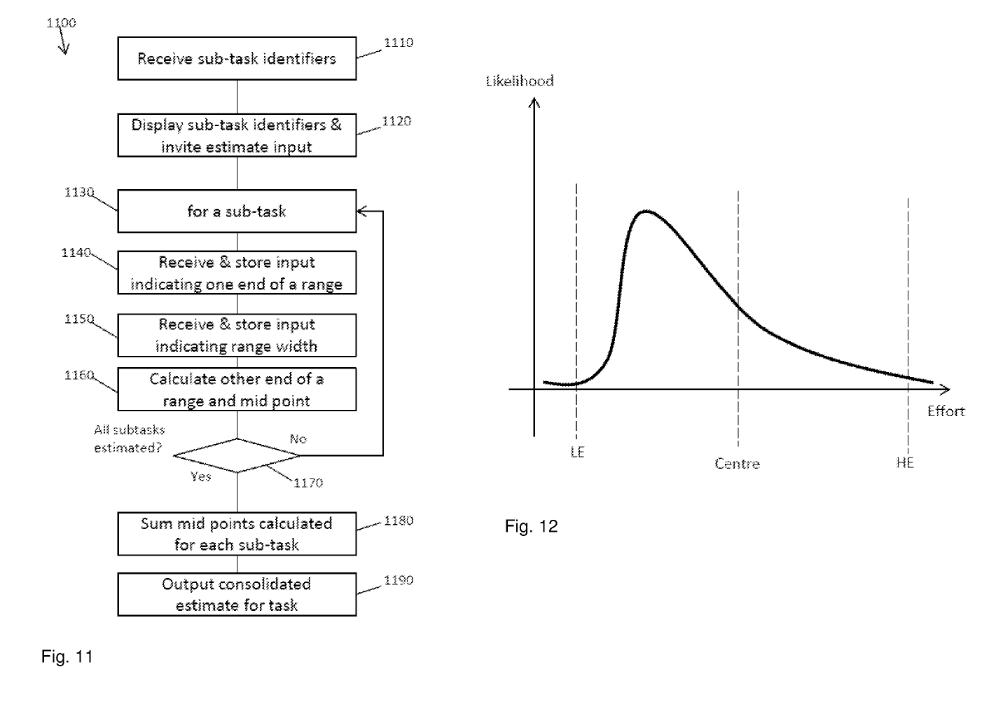

An example of an estimation method in accordance with an embodiment is illustrated in the flowchart of FIG. 11. The disclosed methods and systems provide a quantitative estimation method of generating a consolidated quantitative estimate for a task comprising a plurality of defined sub-tasks. Each task is broken down into a plurality of sub-tasks, the task and sub-task data is stored in a system database or data file. In an embodiment the task and sub-task data is stored in a database accessible to the estimation engine via data communication, for example, via a wired or wireless private network (i.e. Ethernet LAN, WiFi WLAN or combination thereof) or communication network and the Internet.

As shown in FIG. 11, for each one of the plurality of defined sub-tasks of a task, sub-task identifiers are retrieved 1110 from memory 1120, for example using a database query, or extracted from a data file or lookup table etc. A displayed sub-task identifier can be a numeric, alphanumeric, text, an icon, image or any other suitable indication of the sub-task requiring a time estimate, and may provide access to data relevant to the sub-task, including, for example, descriptive content, available resources, time constraints, physical constraints and associated attributes about the sub-task and/or the task. The data relevant to the sub-task may be displayed in response to a user input such as clicking on an icon or button to expand a window or display additional data fields.

The user interface and display driver 930 controls the formatting and rendering for display of the sub-task identifiers 1120, so when displayed a user can input time estimate values. The formatting of data for display may include display of data entry fields or cells and instructions for time estimate value entry. The sub-task identifier can be presented in any form that allows a user, typically a responsible person for the sub-task, to recognise the sub-task and input time estimation data. The data defined for each subtask can include a task/sub-task allocation identifier indicating the team member or team to which the task/sub-task has been allocated. For example, using text, numeric, alphanumeric codes, icons, colours, images, maps etc. Effects such as zoom in and zoom out or expansion and collapsing of tasks and subtasks may also be used to allow visualisation of different levels of detail and granularity of tasks and task breakdown during the estimation process. The user interface and display driver can be configured to selectively render for display sub-tasks for a responsible person or based on allocated users for tasks. For example, subtasks for display may be grouped based on team or team member allocated to the sub-task and display of sub-task ordered by team and/or allocated team member, alternatively only tasks/sub-tasks allocated to a team or team member may be rendered on displays/terminals associated with the allocated team.

For each sub-task 1130 the estimation processor 910 receives and stores in memory a data input indicating a value for one end of a range for the estimate 1140 and a data input indicating range width 350. In a first embodiment the first time value is a low end estimate for the sub-task and the second time value is a value indicating range width, for example a multiplier. In a second embodiment the first input is a high end time estimate for the sub-task and the second time value is a value indicating range width, for example a divisor. The second value may also be a width value. In a third embodiment the first time value is a low end estimate and the second time value is a high end estimate. In response to receiving input of the first time value and the second time value, the estimation processor calculates from the first time value and second time value for the sub-task a low end time value, a high end value, a range width value and a centre value 1160. In the first embodiment described above the low end time value is multiplied by the multiplier to calculate the high end estimate time value. In the second embodiment described above the high end time value is divided by the divisor to calculate the low end time value. In the third embodiment the high end time value is divided by the low end time value to derive a multiplier indicative of the range width. For each of the embodiments the centre value, which may also be referred to as the standard estimate, can be calculated:

center value=(low end estimate+high end estimate)/2 [Eq. 1]

The steps 1130 to 1160 can be repeated until all subtasks for a task have been completed 1170.

In response to having received and processed the first time value and second time value for all sub-tasks of the task 1170, the estimation processor aggregates the centre value for each sub-task of a task to determine the consolidated quantitative estimate for the task 1180, and outputs the consolidated quantitative estimate for the task 1190. The estimate can also be stored in memory or a database. The consolidated estimate may be output to a user via a user interface. Alternatively or additionally the consolidated estimate can be output to one or more further project management or tracking system components, for example a resource scheduling tool. In some embodiments, data output to the project management and work tracking system can also include any one or more of the low end time estimate, high end time estimate, multiplier/range and centre value for sub-tasks. For example, the subtask estimate values output as a data file, data signal or stored in a database part of or accessible to the project management and work tracking system.

Alternative or additional consolidated estimates are contemplated within the scope of this discussion. For example, the data defined for each subtask can include an allocated user identifier the estimation processor is further configured to aggregate the centre value of each sub-task for an allocated user of one or more task to determine a consolidated estimate for the allocated user.

The above consolidated estimate generation can be repeated for a plurality of tasks, for example a group of tasks making up a body of work, and a further consolidated estimate generated for a plurality of tasks by aggregating the consolidated estimates for each task.

Consolidated estimates may also be prepared based on a team of allocated users or other task attributes, for example project critical path tasks, project phase, physical resource based task or subtask grouping etc.

Embodiments include the estimate range ends and width which are determined from two input subjective values. For example, in one embodiment one value indicates one end of an estimation range and the other value indicates the width of the range. The person responsible for making the estimation, the responsible person, can be instructed to choose the values to input as subjective low granularity estimates, that the responsible person has high confidence that the sub-task outcome can be achieved or delivered within the estimate range. For example, the first value may be a very optimistic estimate, which the user has a high confidence in being a “best case scenario” but not beyond feasibility for execution of the subtask, for example 85-90% confident that a better result will not be achieved. The other value indicative of the width may be indicative of the other end of the range, or a multiplier “n”, for example, based on the reasoning that after nominating an optimistic estimate value a pessimistic estimate may be n times the optimistic estimate. For example, 85-90% confident that a “worst case” would not be more than triple the time estimated for the “best case”. This estimate input request enables users to input an intuitive “guess” estimate range, using only 2 numbers, which requires little effort to come up with but the responsible person is reasonably certain and prepared to commit to an outcome being achieved somewhere within that range. This system acknowledges that estimation of work is typically inaccurate. Further, by providing an end point and range, or two end points, it is easier for a person to consider other factors which may affect their performance during the task duration, for example state of health, concurrent workload, reliance on external deliverables and other obligation/commitments that may impact on the task execution. Variables and unknowns can be accommodated in the estimation system simply by increasing the multiplier and hence range width.

It should be appreciated that the responsible person, may be an experienced project team making estimates for tasks for which they are responsible for delivering, tasks allocated to that user. The responsible person may also make estimates on behalf of other (typically less experienced or not yet allocated) team members. The responsible person may, in some circumstances, the responsible person may be a notional “responsible person” with the estimate in fact being provided and committed to by a project team. The two estimate values are input by a user, who may be the responsible person or may be another user inputting values with input or under instruction of the responsible person.

Embodiments of the methods and systems enable estimates to be made independent of an attempt to characterise or assume a probability distribution of outcomes. From historical and empirical evidence it has been observed that, typically for professional services and in particular software development, task outcome probabilities tend to show a positively skewed distribution (an example is shown in FIG. 4) with a longer tail on the right of the distribution, therefore estimation theories based around normal distributions is typically flawed. Further, the distribution can change from task to task and due to the unknowns for estimation of software projects the actual distribution cannot be predicted with any accuracy in the planning phase of a project.

The disclosed methods and the systems provide a simplified estimation method robust against varying probability distributions. Estimators which may be responsible persons are asked to make a low estimate (90% sure they cannot beat it), which compels one to consider an optimistic and probably lucky low number. Then apply a multiplier, which can be referred to as an “X factor” (a multiplication factor), from which a high end estimate can be derived. In one embodiment the system restricts the multiplier value to being an integer value. The reason an integer value is preferred for a multiplier is because prediction with better accuracy is unlikely without the benefit of hindsight. For example, it may be shown that a correct multiplier was 2.1 with the benefit of hindsight. However, when trying to make predictions humans do not estimate with accuracy. In invoking a predictive and subjective heuristic for coming up with a number, and the method does not suffer the side-effects of the illusion of accuracy and does not suffer from needing historical data. FIG. 12 is an example of a skewed probability distribution indicative of likely time taken for a software project task, the low end (LE) estimate, 85% to 90% confidence a better result would not be achieved, and high end (HE) estimate, 85% to 90% confident the work can be done by this time, are easier to predict and commit to achieving than the mean, median, mode, deviation and skew of the distribution.

An advantage of the disclosed embodiments is that the estimation for a task only requires two numbers, indicative of a range without making any commitment to a “most likely” outcome within that range or assumption of a particular statistical distribution.

Empirical test evidence shows that this estimation system does not seem to suffer as badly from human factors as known previously methods. The reason that it works is that it encourages a responsible person to simultaneously consider the optimistic and pessimistic outcome and give a rating, indicative of a degree of confidence they have in their number. If it is a tight skew, it will have a low multiplier. If it is a long skew, it will have a high multiplier. Thus, a qualitative assessment of the median is provided whilst also providing a qualitative assessment of the spread. So from two numbers, the disclosed systems and methods can determine the range endpoints and width. From these values a fourth value can be calculated, which is the average of the high and the low (the standard estimate). This centre value for sub-tasks is aggregated to provide the consolidated estimate for the task.

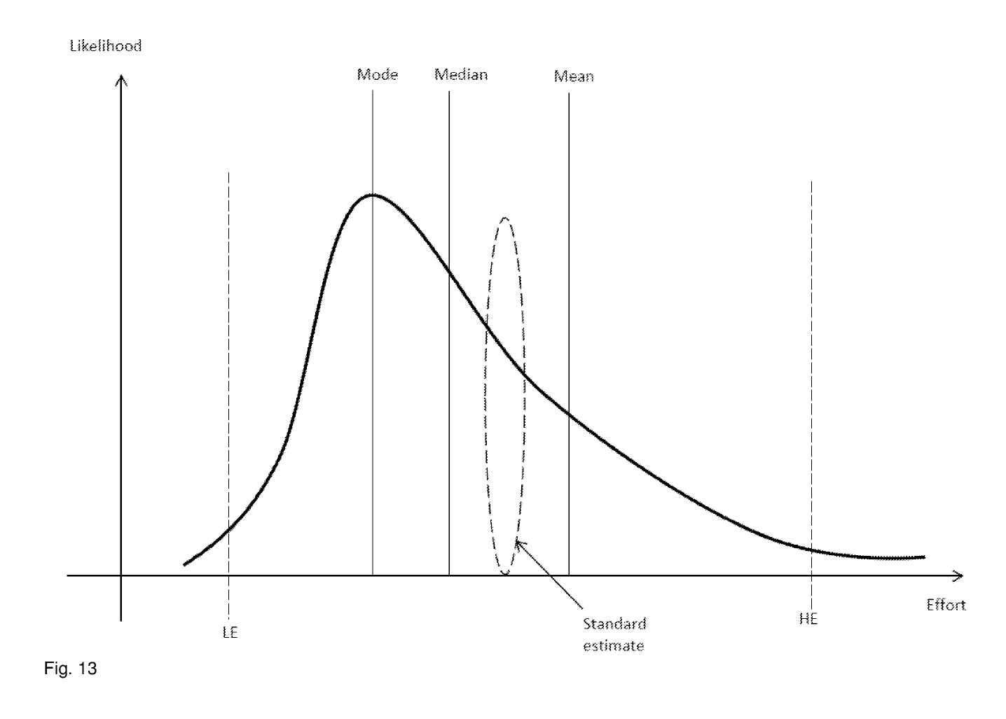

Additionally, from empirical test evidence illustrated in FIG. 13, it has been found that the standard estimate is likely to be slightly higher than the median and the mode. The empirical test evidence of the standard estimate provides a slightly more paranoid estimate, closer to the likely mean probability.

The applicant has found from test data that even for relatively small sample sizes, around 12-24 people, even though there may be high variety in optimism and pessimism between individual estimators, the aggregated consolidated estimate value has been shown to give a reasonable prediction of the task effort outcome. Test evidence indicates that projects that are estimated using the disclosed methods and systems have been shown to be much easier to bring in on time, than projects estimated using a statistical factor method. The problem with the three or four point statistical estimation methods is that people don't have the data to enable an accurate estimate, but the method provides an (unreliable) illusion of accuracy which can, in turn, lead to unrealistic expectations and frustration.

The disclosed estimation methods and systems starts from a presumption of inaccuracy and acknowledgement of subjectiveness of estimates. By asking for estimators to identify a range that they have high confidence of being able to achieve an outcome somewhere within that band, there is no requirement to specify any “most likely” outcome. The range or band is nominated based on either an optimistic or a pessimistic outcome estimate and an integer multiplier—indicative of variability of the work being estimated. Thus, the estimation values are input independent of any particular probability distribution shape or requirement to commit to any particular value within the band.

The width of the band can be indicative of how confident the estimator is to estimate the work. For example, a low value multiplier is a narrow band indicating low variability between the high and low estimates, whereas a sub-task with many unknowns may have a high multiplier value indicating low confidence in the ability to accurately estimate the required effort. By aggregating mid points of the bands for the consolidated estimates this assumes inaccuracies will “even out” in the end. This method has been found to produce much more commercially useable numbers than any other method the applicant has observed. Further the applicant has used retrospective data to identify estimators who are typically pessimistic and those who are typically optimistic and observed that there is a normalising effect. The optimists are happy to consider the low estimate and a “risky factor”, whereas the pessimists are happy to consider the high estimate and a “lucky factor”.

Further, empirical evidence has shown that network effects are typically accommodated within the estimates, as the estimates are subjective and estimators can instinctively adjust estimates based on anticipated parallel or serial tasks. For example, allowing extra time between optimistic and pessimistic estimates for tasks that are likely to be worked on in parallel or have some dependency.

Examples of estimation methods and systems have been discussed above with reference to project planning, work task scheduling and tracking which typically use time based estimates. However, the described estimation methods and systems may be employed for estimating values other than time, for example monetary values for professional services where deadlines may be fixed but costs dependent on the resources applied to the tasks. For example, planning deadline based services such as legal or contract services. In another example, for example for delivery or logistics planning estimates may be based on anticipated speed and distance, for example for sea or air freight enabling alternative routing and speed based on environmental factors to be accommodated for in a planning process. It should be appreciated that embodiments of the systems and methods described above may be utilised in a variety of planning and tracking systems.

The disclosed systems and methods can be retrofitted into current or existing scheduling systems making those systems more robust. Current or existing systems may have additional parameters providing computations specific to the industry in which they are applied. Utilising the same or different hardware, the disclosed systems and methods can enhance those systems as a retrofit, improving their results.

In a manufacturing environment or plant, where for example a customisation unit assembles products for specific orders, the products need to move through the manufacturing plant for assembly, and preferably do so in the most efficient and productive manner. Customisation is common, for example, in the computer industry where a buyer orders a computer with a customised specification. In preparing for delivery of that computer, the manufacturer will build the computer for the customer. Tasks for customisation may be without an established time history.

Customisation is common in many businesses and industries where a larger task including sub-tasks or different smaller tasks may be required on short notice and where a history of the time taken for one or more of the sub-tasks is not available. While this example is related to a high tech industry, the same would hold true of any industry. One can consider the same discussion for custom furniture building, framing, construction, landscaping, and so on that may have existing scheduling systems specific to their industries.

In a manufacturing environment, while tasks can be repetitive, their initial establishment can require the time estimation as described herein. The disclosed systems and methods, for example, may be used prior to establishing a history. The history may be found to be equal to the time estimate in accordance with the disclosed systems and methods.

Many different tasks may be involved in a manufacturing process. In the example of custom computer building, the task of building a computer to specification, the sub-tasks may include fetching a component, positioning the component into a computer casing, connecting the component to other components, securing the component within the casing, moving the computer to the next assembly station, and so on. For specific customised orders as described immediately above, different combinations of previously time estimated sub-tasks may be required so the aggregation of those time estimations can be provided by the systems and methods described herein. In this way, the disclosed methods and systems can be retrofitted into existing scheduling systems, changing an existing system to having the capability to build in time estimates and the aggregation in the manner that is described herein, and ultimately, providing a robust outcome for time estimation where history is unavailable.

It may be found in some circumstances that the step of establishing a time history is not necessary when a particular scheduling system is retrofitted with the disclosed time estimation systems and methods. The robustness of the disclosed systems and methods may replace the need to monitor time to establish a historical value. A transformation of an existing scheduling system with a retrofit of the disclosed time estimation systems and methods may eliminate the need for the step of establishing a time history and replacing that with the estimated time based upon the retrofitted system.

While the discussion above is with respect to time estimates and utilisation of acceptability bands with respect to time estimates, it will be understood that a product with an acceptability band sub-product is applicable to different types of components or sub-tasks of tasks. A component may be considered a small part of an overall project where a plurality of components are pieced together in series and/or parallel to carry out a task. Potentially a component can be a subtask as described with respect to the x-factor product as described below. Components can be named in any suitable manner. Another term, used below is “filter strips”. This is a term that is used in the drop down menus of FIGS. 7a and 7b. Any term that is criteria that is used to interrogate the database is a filter strip. Acceptability bands use criteria and therefore the term filter strip is used in conjunction with acceptability bands as well.

FIG. 14 depicts some configured acceptability bands that are utilised in a workflow management system as they established with respect to different components. While some of the above discussion has been with regard to time estimates, as is shown, different acceptability bands can be applied to one component which may not refer to time estimates. For example, the component entitled “waiting on capacity”, there are at least ten different acceptability bands configured for that component. A filter strip is another term used a Also, in the column called “type” the different types can configure how the output is presented. For example, NUP provides the number of matching workflows as a percent of the total number of workflows in the component; AGR provides aggregate workflows returned by filter strips using SQL; NUM provides number of matching workflows; REL provides the time between now and when an item matching the filter strips was most recently released to the buffer; DUP provides the planned duration of all matching workflows as a percent of planned duration of all workflows in the components; QAG provides the time between now and when the earliest open, un-released item was added to a work queue, SQL provide SQL; and DUR provides the total planned duration of all open items matching the filter strips. The list of FIG. 14 is of course is a partial list of configured acceptability bands and does not limit the scope of this discussion.

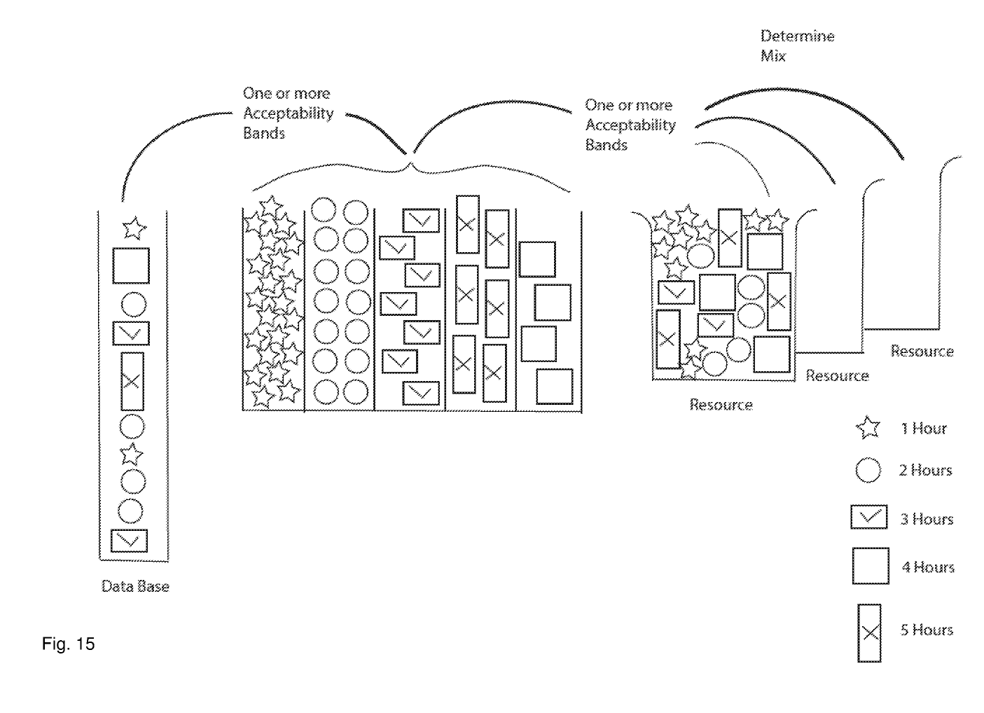

FIG. 15 depicts workflow items subjected to one or more acceptability bands. FIG. 15 further depicts that one or more acceptability bands can be applied at various stages of the workflow management system. The icons are used to represent workflow items that have time estimates associated with them and potentially other workflow variants. As illustrated in FIG. 14, a component may have more than one acceptability band associated with it as discussed above. One or more processes involving acceptability bands as described above may be applied to workflow items before the workflow items are assigned to resources.

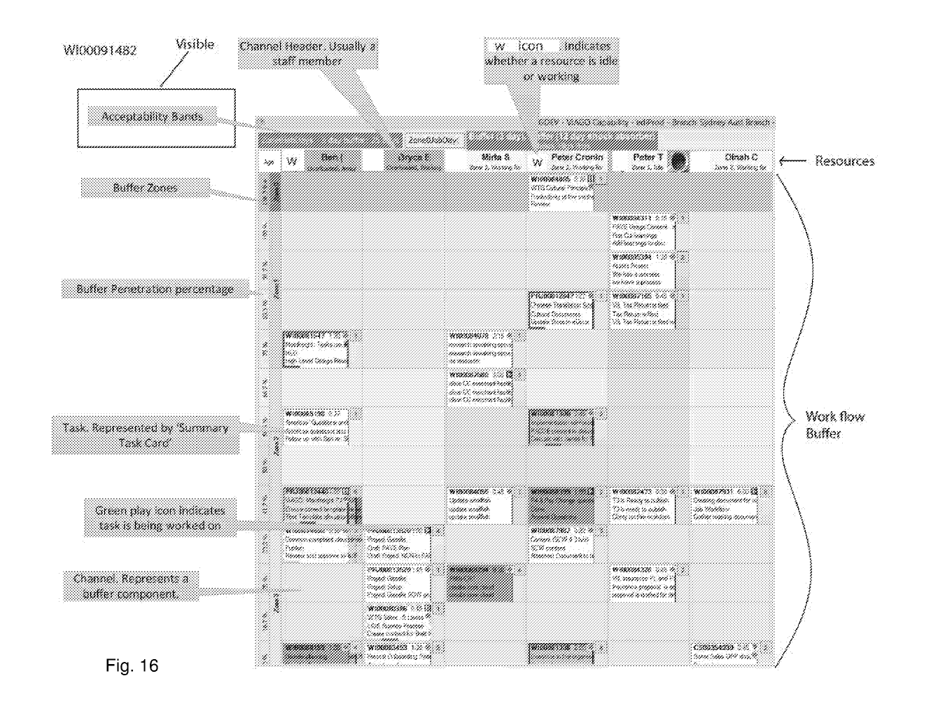

FIG. 16 depicts a screen shot of a workflow buffer to give context to the output that may be provided by the utilisation of acceptability bands. As mentioned, acceptability bands can be running in the background on components that do not necessarily generate workflow items that move to the workflow buffer. However, in the context of acceptability bands that do provide workflow items to the workflow buffer, FIG. 16 depicts examples of workflow items delivered to resources.

It will be understood to persons skilled in the art that many modifications may be made without departing from the spirit and scope of the invention. It should be appreciated that in the context of the present specification the terms “module” and “component” are used to refer to a system component implementing defined functionality. The system component can be implemented as a software program executable using a processor or as a software routine integrated into a software program providing additional functionality. The system component may be equally implemented using a combination of hardware and software. The disclosed embodiments may be implemented using any suitable combination of hardware, software and firmware, and may utilise a combination of shared and dedicated data processing hardware and memory resources. For example, a dedicated hardware circuit, such as an application specific integrated circuit (ASIC) for programmable logic such as a field programmable gate array (FPGA) or programmable logic controller (PLC), may be used to implement some system functionality. This hardware circuit may be used in a data processing system having at least one processor, memory and other resources for executing cooperating firmware and software to support the full functionality of the system and integrate with external systems such as user terminals. It should be appreciated that many alternative system architectures could be used to implement the system and all such alternatives are envisaged within the scope of the present application.

The systems and methods disclosed herein can be used to indicate a risk state metric and value. It can be referred to as acceptability band as the band defines how acceptable that metric is for the particular purpose. In one example, a lower value preferable over a higher value. In one example, the metric is based on an amount of time recorded as a percentage of time scheduled.

It is noted that in previous systems, workflow items are sorted by due date. However, in a massively parallel operation of resources, this ordering leads to highly inefficient assignments of workflow items. The current approach allows the sequence to change on the fly based on the workflow items that are currently assigned to that resource.

The workflow items can be separated into released and unreleased workflow items. If a workflow item is released it is allowed to work on them with some flexibility. That is the sequence or ordering of the workflow item can be changed. The set of released workflow items may also be referred to as ‘buffer’. Unreleased means that the resource is not allowed to work on them. The effect is that this limits re-sequencing of unreleased workflow items. In other words, there may be a first container and a second container of workflow items. Workflow items of an entire month, for example, are entered into the first container and out of those five priority workflow items are entered into the second container. Now, the resource has the flexibility of deciding which of the five workflow items from the second container to select first. However, the resource is not allowed to bring forward any of the workflow items in the first container. The rules of moving between first and second container are a function of the workflow items in the second container and formalised herein in the form of the acceptability bands.

In one example, workflow items are categorised by size, colour and flavour. A resource may not be allowed more than one of any colour and must have two of any flavour. However, the resource may have one or two of any size. In order to enter a workflow item into the second container (buffer), the system takes the first workflow item and checks whether it violates the desired metric (i.e. is outside the acceptability band) and how badly it violates the metric. The system then determines a mix of workflow items in the second container to achieve the best numerical value based on the selected metric.

In one example, the selection of workflow items to be entered into the second container is based on processing time. The acceptability band may include how long the workflow item has already remained in the second container. The acceptability band can be configured so that workflow items are not allowed to get older than a predefined threshold. One advantage is that a wide variety of mix and release metrics can be configured that capture the rules of moving workflow items from the first container into the second container.

### Filter Superset Workflows for NUP and DUP Acceptability Bands

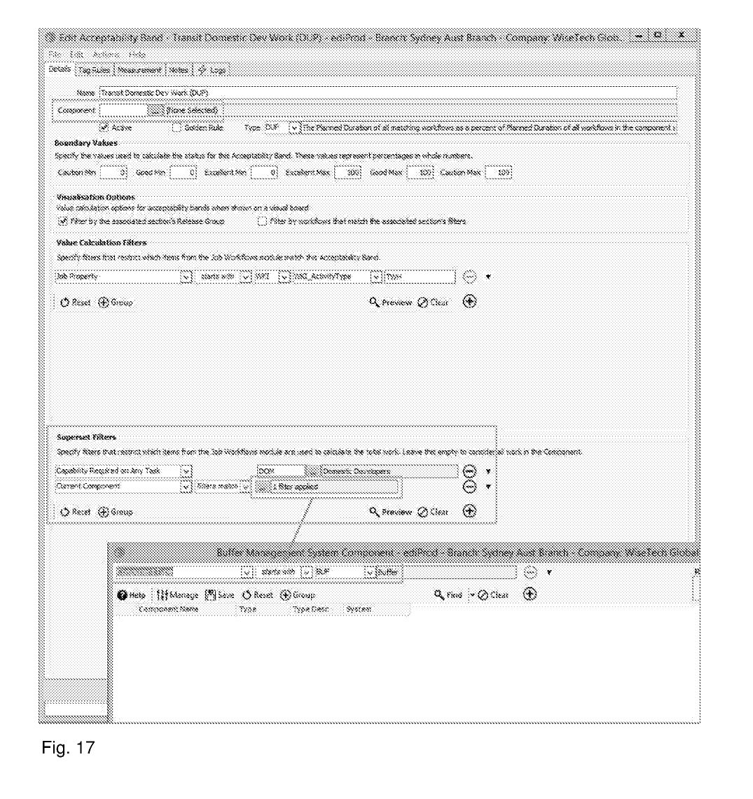

This enhancement refines the value calculation aspect so an acceptability band can be refined to a subset of the relevant workflow items. For example, FIG. 17 shows a screenshot with an AB which in natural language would read:

Find the percentage of work whose Activity Type is TWH, out of all the work where any task requires the DOM capability and is currently located in a buffer.

One change is the introduction of Superset Filters, which further refines the total body of workflow items which are considered as part of the superset, out of which the Value Calculation Filters specify which items are considered “matching” when calculating the current value of the acceptability band, in percentage terms. Previously, the total body of workflow items considered part of the superset is limited to workflow items that reside in the Buffer Management System component specified in the Component field above, and assigned to the relevant team (Release Group). These still apply with the introduction of Superset Filters.

In one example, processor 110 creates Acceptability Bands that highlight risk associated with the desirability of a mix of work in a more refined way. Acceptability Bands can now calculate a percentage of a type of work within a subset of all work in the group of resources, such as a team, as opposed to a percentage of a type of work within all work in the team.

This change enables the Release Gate to maintain a more flexible mix of work discrete business units rather than just for a company as a whole. It is now possible to create Acceptability Bands such as the following examples:
The percentage of work with a particular tag within all AIR shipments.
The percentage of work for one Work Item activity type within a particular Work Item area.

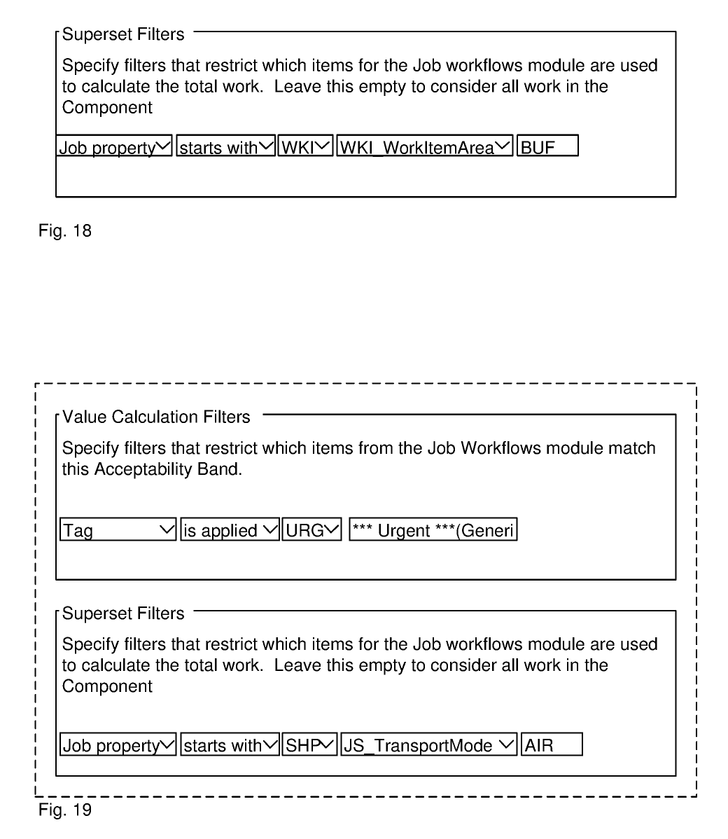

FIG. 18 illustrates a user interface where a new set of filter strips can be added to the Acceptability Band form when the Type field is set to Number of workflows as a Percentage (NUP) or Duration of workflows as a Percentage (DUP). These Superset Filters limit the scope of workflows considered when calculating the percentage of workflows matching this band.

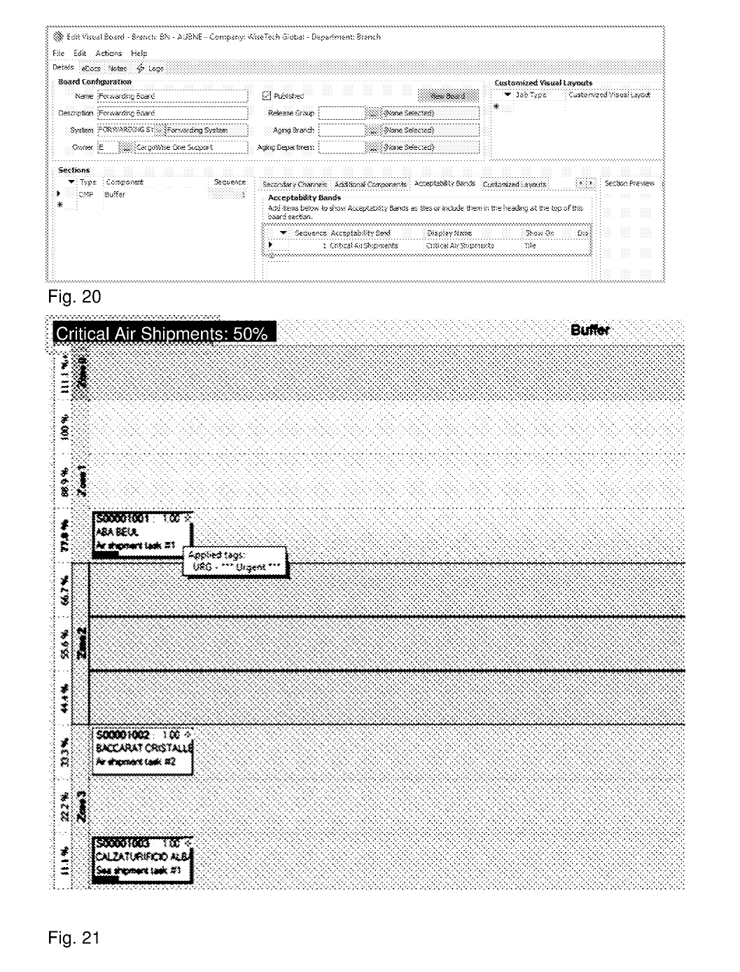

In the example of FIG. 19, the Acceptability Band is configured to show the percentage of AIR shipments which have a particular tag applied. FIG. 20 illustrates how the above Acceptability Band can be configured to show as a tile on the “Forwarding Board” and the result is shown in FIG. 21. The value shown is 50%, indicating that 50% of all items calculated in the Superset Filters also match the Value Calculation Filters. This excludes the ‘Sea shipment task #1’ because even though it matches the Value Calculation Filters, it is not an AIR shipment so does not match the Superset Filters. When selecting Highlight Matching Items, processor 110 filters out the SEA shipment tasks which also have the tag applied.

### Reusable Acceptability Bands

This enhancement refines the value calculation aspect so that the same acceptability band definition can be re-used in multiple contexts without changing its saved definition. For example, an acceptability band may be used to calculate the percentage of one type of workflow items compared with another. This band may be displayed on one visual board for a team, and another board for a subset of that team, or just an individual. The determination of workflow items which match are filtered to include only those items which are shown on that visual board.

The following examples show how the calculation of the Defect % acceptability band differs based on which board it is viewed on. When viewed on the ‘team board’ it shows that 60.95% of workflow items currently in front of the team is classified as a defect fix. When viewed on a board just for one individual, the value is calculated based on workflow items in front of that person only.

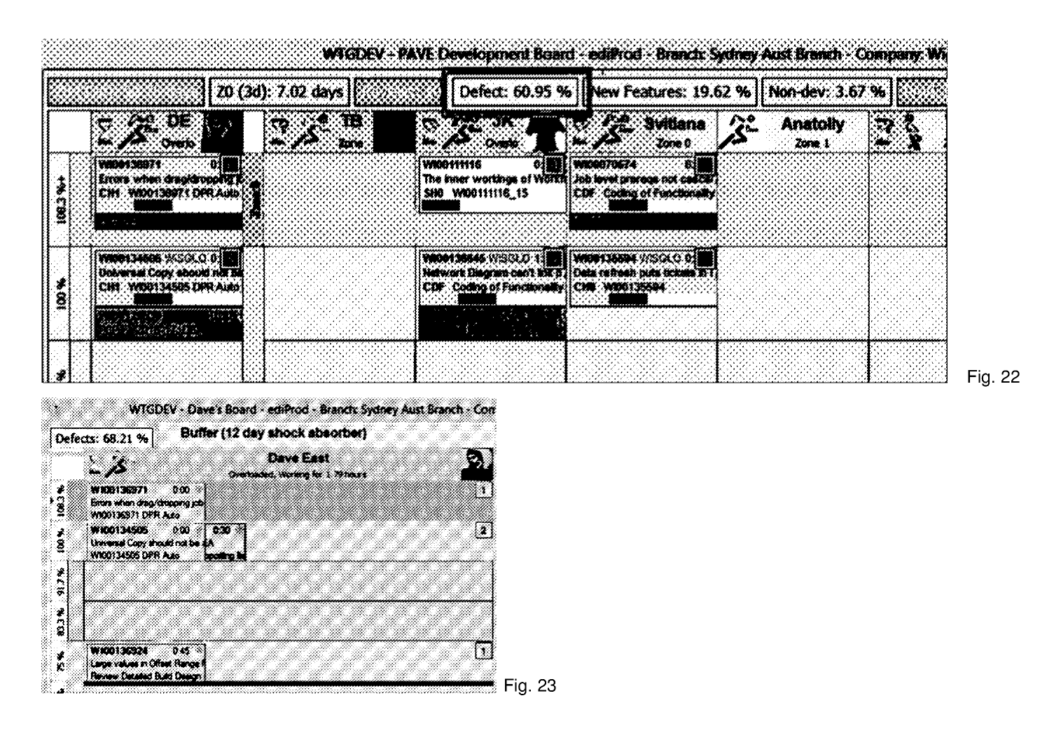

FIG. 22 shows a team board and FIG. 23 shows an individual board. This interacts with the above Superset Filters functionality in that both the matching set of workflow items and the superset of workflow items are filtered based on what is shown on the board on which the acceptability band is displayed. It is possible to specify the default behaviour of whether an acceptability band uses the context of the board section on which it is shown when calculating the value. This can be done on the acceptability band itself, or overridden when configuring that the acceptability band will be shown on a board section. It is also possible to configure whether the acceptability band uses the context of all workflow items assigned to a team of people (Release Group) when calculating a value. This is configured and overridable in the same way.

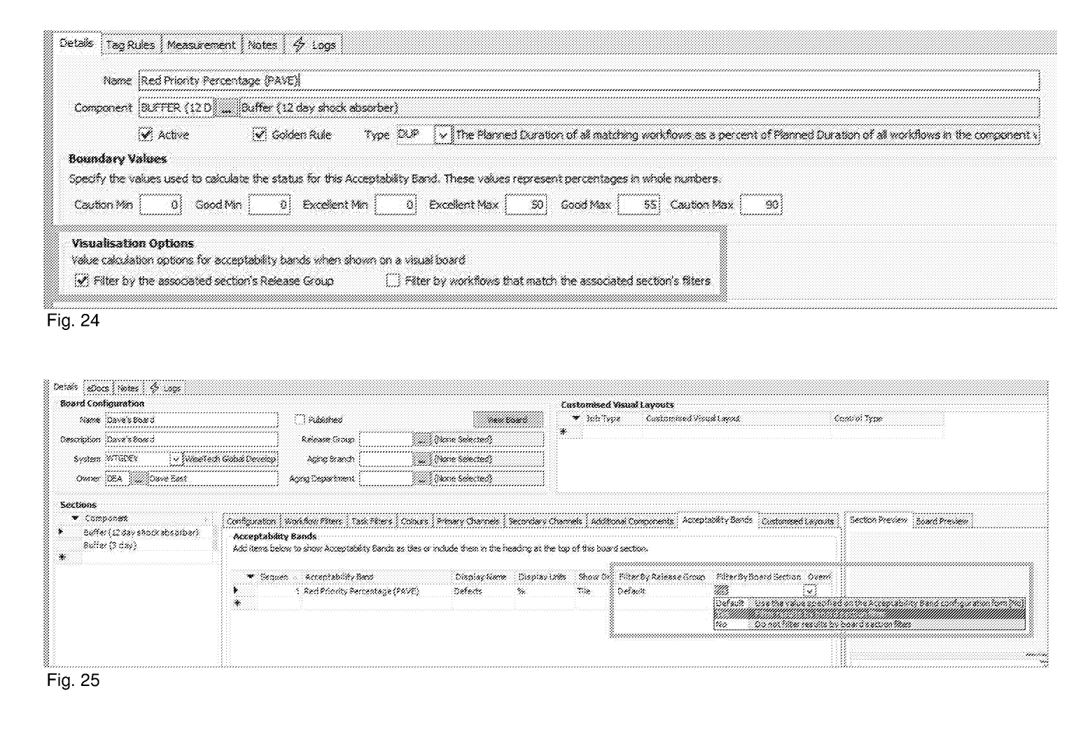

FIG. 24 shows how default values are specified on the acceptability band while FIG. 25 illustrates how overridden values are specified on the board configuration form.

This enhancement also introduced the ability to change the boundary values which control the target ranges into which a calculated value is placed (e.g. Excellent, Good, Caution, High Risk). This enables the customisation of risk states based on the board on which the acceptability band is viewed. For example, one team may consider a range of 40% to 50% to be Excellent for a given category of workflow items. Another team may consider 50% to 60% to be Excellent for the same category of workflow items.

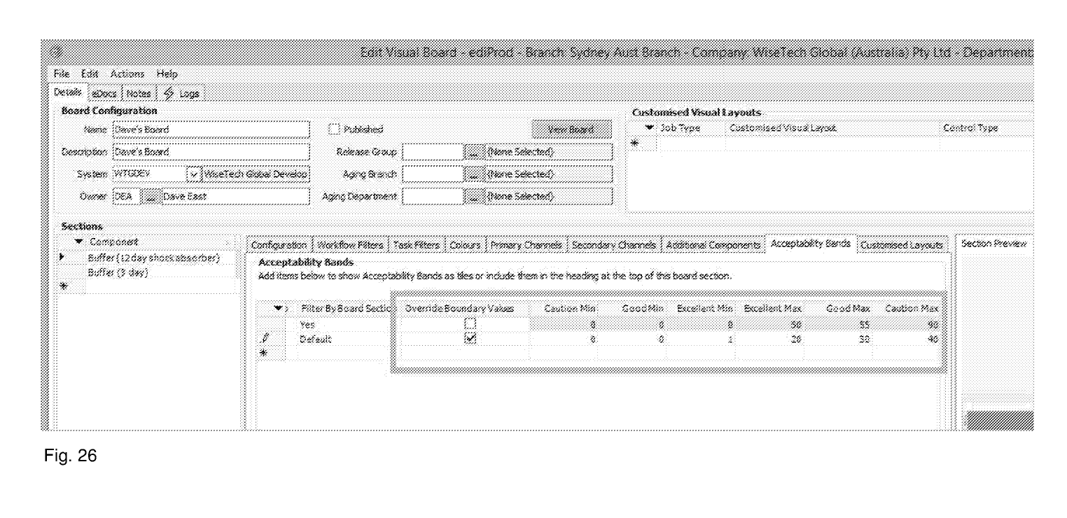

FIG. 26 shows how one acceptability band is configured to override the pre-configured boundary values.

### Acceptability Band Section Heading

This enhancement allows the refinement of which acceptability bands are included in the board section heading ‘summary’ of overall risk state for a Buffer Management System component. Acceptability bands can be included to be shown as a tile offering high visibility, or made to appear in the list of bands that are used to calculate overall acceptability of a Buffer Management System component, or both visualisation options. FIG. 27 illustrates a user interface for configuring the acceptability band section heading.

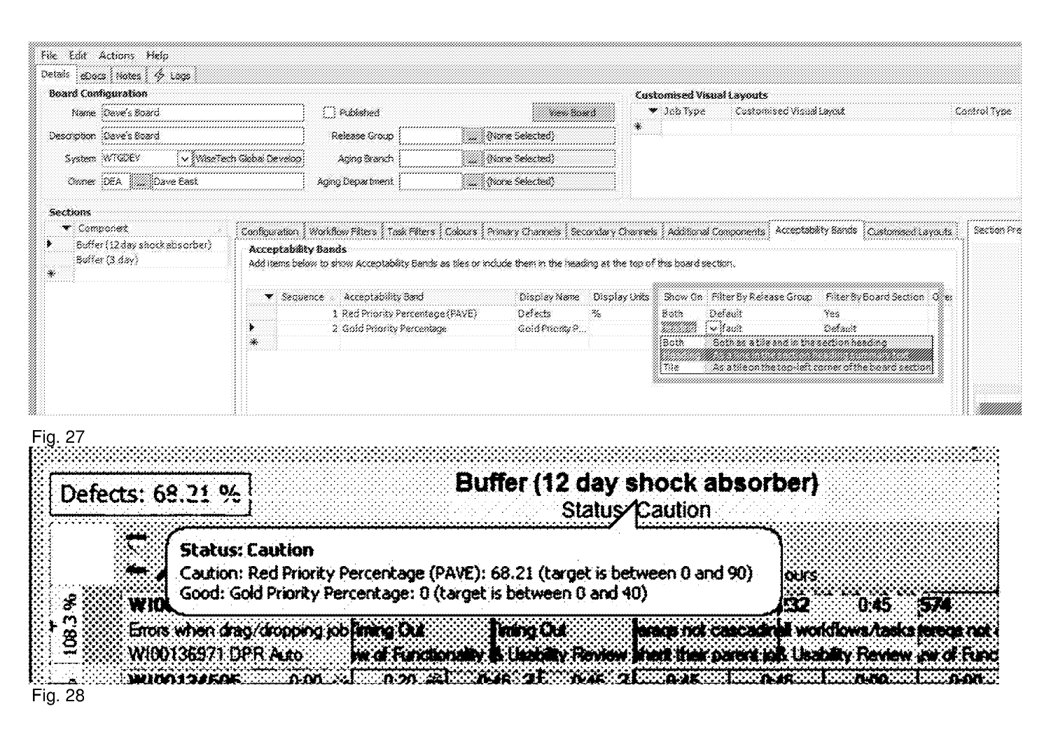

The overall risk state of a Buffer Management System component can be considered to be the worst-case of the current risk state all relevant acceptability bands (starting with High Risk, then Caution, then Good, then Excellent). For example, FIG. 28 shows a heading with Caution status.

This reduces the amount of detail shown on the board section heading balloon, since only the required bands are listed, improving the usefulness of the risk state indicator since non-relevant Acceptability Bands are not considered. This reduces “broken window syndrome” which can cause important metrics to be ignored when those metrics are viewed along with other metrics that are not relevant to a group of people.

### Viewing all Results of an Acceptability Band

This enhancement allows the specific workflow items which have been included in the value calculation of the acceptability band in the given context (board section, Release Group) to be shown in a list.

### X-Factor

Further disclosed are quantitative time estimation methods and systems of a project management system. Utilising a display driver and a processor, methods include rendering for display a sub-task identifier and one or more user input fields for a sub-task representing high confidence assessment of a first time estimate value and a high confidence assessment of a second time estimate value for the sub-task. The second time estimate value is a multiplier or divisor value representing high confidence assessment of variability from the first time estimate value. The disclosed method further includes from user input, the processor generating an associated centre value derived from two of the low end time value, the high end time value and the range width value and the processor aggregating the associated centre value for each sub-task of a task to generate a consolidated quantitative time estimate for the task for utilisation in the project management system.

In a disclosed quantitative time estimation system, the system can include a display driver, a processor and a database. The database can be for storing in a task definition storage location of the database task data representative of one or more defined tasks and wherein each task comprises a plurality of sub-tasks, wherein data elements representative of each of the sub-tasks are separately stored in data fields defined in the database, the data representing each-sub task including a sub-task identifier data element. The display driver can be configured to generate for display on a display screen, a user interface displaying at least one sub-task identifier and provide input fields to input a first time estimate value and a second time estimate value for the sub-task, wherein the first time estimate value is a quantitative value representing high confidence assessment of one end of a time estimate range, and the second time estimate value is a quantitative value representing high confidence assessment of the other end of the time estimate range. The processor can be configured to, in response to receiving data input of the first time estimate value and the second time estimate value, determine using the first time estimate value and the second time estimate value for the sub-task, a low end time value, a high end time value, and a range width value and store the low end time value, high end time value, and range width value as data elements for the sub-task in data fields defined in the database, generate for the sub-task an associated centre value derived from the low end time value and the high end time value and store the associated centre value as a data element for the subtask in a data field defined in the database. The processor can be further configured to provide output representative that an associated centre value has been stored for all sub-tasks of a task and aggregate the associated centre value for each sub-task of a task to determine the consolidated quantitative time estimate for the task. The processor can be further configured to output the consolidated quantitative time estimate for the task for utilisation in a project management system.

The disclosed project management systems and methods include a data base for storing in a task definition storage location, task data representative of one or more defined tasks and wherein each task includes a plurality of sub-tasks. Data elements representative of each of the sub-tasks are separately stored in data fields defined in the database, the data representing each-sub task including a sub-task identifier data element. A processor can be in data communication with the database, the processor configured to automatically update task and sub-task data stored in the database in response to receiving data input indicative of task planning and execution. A display driver can be configured to generate and display on a display screen, a user interface to enable data input to define tasks and sub-task in the task definition storage location of the database, wherein for a project planning phase the display driver can be configured to generate for display on a display screen, a user interface displaying at least one sub-task identifier and providing input fields to input a first time estimate value and a second time estimate value for the sub-task, wherein the first time estimate value is a quantitative value representing high confidence assessment of one end of a time estimate range, and the second time estimate value is a quantitative value representing high confidence assessment of the other end of the time estimate range. The processor can be configured to, in response to receiving data input of the first time estimate value and the second time estimate value, determine using the first time estimate value and the second time estimate value for the sub-task, a low end time value, a high end time value, a range width value and store the low end time value, high end time value, and range value as data elements for the sub-task in data fields defined in the database. The process can furthermore be configured to generate for the sub-task an associated centre value derived from the low end time value and the high end time value and store the associated centre value as a data element for the subtask in a data field defined in the database. The processor can be also configured to provide output representative that an associated centre value has been stored for all sub-tasks of a task, aggregate the associated centre value for each sub-task of a task to determine the consolidated quantitative time estimate for the task, store the consolidated quantitative time estimate. The processor can be further configured to apply the consolidated quantitative time estimate for one or more tasks in an automated task scheduling process.

The disclosed systems and methods provide a computer system implemented quantitative estimation method and system enabling generation of a consolidated estimate for a task comprising a plurality of sub-tasks. In a first example the system comprises an estimation processor which utilises a task definition data file or database and a user interface and display driver to facilitate communication with user terminals or other input and output devices. The task definition data file or database stores data for one or more tasks broken down into sub-tasks. The estimation processor is configured to, for each task, trigger the user interface and display driver to cause display of sub-task data to users and receive input of a first value and a second value for each subtask. In response to receiving data input of the first and second values, the estimation processor 110 determine an estimated range for the sub-task. From these two values only the estimation processor determines, for a range, a low end estimate, a high end estimate, a range width and a centre value. The estimation processor determines a consolidated estimate by aggregating the centre values calculated for each sub-task from the input values for all the subtasks of a task.

The disclosed systems and methods can be utilised as an component of a project management or work tracking system or as a standalone estimation system. An example of a project management and work tracking system incorporating an embodiment of the estimation method is illustrated in FIG. 2. The project management and work tracking system is implemented in a computer system environment comprising processor resources and memory resources used to implement program system functionality including scheduling of tasks/sub-tasks and tracking execution by a scheduler/tracker using defined task and sub-task data and managing acquisition and dissemination of project data from users by a user interface and display controller 260.

Project tasks are broken down into sub tasks and the task/subtask data stored in memory 220, for example as one or more data files or in a database structure. The scheduler/tracker is configured to enable project data to be entered into the system for initial project definition and project execution tracking. The scheduler/tracker may provide tools to facilitate the initial task definition and subtask breakdown from higher level project specifications and requirements, and task/subtask scheduling. The scheduler/tracker may facilitate task and sub-task definition and storage in a task definition storage location of a database task data representative of one or more defined tasks and sub-tasks. Data elements representative of each of the sub-tasks can be separately stored in data fields defined in the database, the data representing each-sub task including a sub-task identifier data element which can be used to render for display information to allow a user to identify the subtask. The scheduler/tracker may include functionality for automated monitoring and update of project execution data. For example, managers and team leaders may input initial project task and subtask definitions and initial data, the data for these subtasks can be subsequently updated manually or automatically based on activity of project team members, for example in response to deliverable being completed or periodic status updates of work progress input form user terminals and updated in the system memory 220. The user interface and display controller is configured to control display of project information to users, (for example, via their user terminals 240a-c or common resources such as a project tracking display screen 250), outputting of reports, and receipt of input data from users, for example from networked user terminals 240a-c. For example, the user interface and display controller may be configured to control presentation of a display screen displaying sub-task identification data and data fields allowing input of estimation values, for example estimation of effort required for completion of a task which will typically be a time based estimate. This may include display of graphical user interfaces to assist input of data values, for example displaying duration selection sliders, date selectors etc. manipulable by a user to graphically indicate a numerical value, for example, number of person minutes or hours, calendar based estimates etc.

The user interface and display controller may also be configured to perform data transformation of input data from a file input into alternative file formats or database entries. For example, conversion of a data input in a spreadsheet format to database data entries. Input format conversion may also convert input data from input formats incompatible with other system components into compatible formats. Alternatively an input interface and display controller embodiment may be configured to perform data extraction or data mining to automatically identify project relevant data from monitored inputs or associated systems, for example data mining from change requests, and extraction of project relevant time entries from a timekeeping system. It should be appreciated that the above described examples of project management and work tracking functionality is non-limiting and the different functions implemented by the project management and work tracking system will vary between embodiments and different functions can be implemented to tailor the system for different project environments.

The system can be implemented using a variety of different system architectures. For example, in an embodiment the processor and memory resources may be provided by a general purpose computer such as a personal computer (PC), laptop/tablet computer, or server having internal memory including volatile (for example, random access memory RAM, buffers etc.) and non-volatile (hard disk, solid state memory, optical disk etc.) memory resources and optionally external memory resources accessible by the processor via wired or wireless data connections. In alternative embodiments the processor and memory resources may be network accessible distributed resources, for example distributed processing and memory resources within a company network, or “cloud based” on demand processing a memory resources accessible via the internet.

In this example the project management system processing and memory resources are in data communication with user terminals and other communication resources such as display screens via a network. For example, the network may be a local area network, such as an Ethernet network or secure WiFi within a company premises, or a secure intranet. Alternatively, the network may be a public network such as a telecommunication network or the Internet. The user terminals may be laptop or desktop computers, tablets or smart phones etc., having input interfaces such as keyboards, touch screens, scanners, transceivers, microphones and sensors (for example, sensors for motion, speed, temperature, humidity, light, location etc.). Output interfaces can include display screens, speakers, printers etc. The types of input and output devices provides at a user terminal can vary between users terminals and many variation of terminals can be supported by any one system embodiment.

The system functionality is implemented in some embodiments as one or more software programs which execute using the processing and memory resources as described above and interact with external interfaces of the networked computers. The system may be implemented as software programs or routines executable using the processing and memory resources which are accessible via a network from one or more user terminals which provide user interface capability and local processing capability and memory. In alternative embodiments some system functionality may be implemented using a combination of hardware and software. For example, the network may be a local area network, such as an Ethernet network within a company premises, or a secure intranet. Different users may be enabled access to the system for specific purposes only. For example, some employees or job categories may be provided with access to view a broad range of data but limited to updating only defined data elements, typically related to work defined for the user. Other users, such as project managers and team leaders may be provided access to enable viewing and updating of broader ranges of data. In some embodiments, updating of some categories of data may be restricted to ensure that only the user to whom work is allocated or an authorised delegate may update the data relating to the work.

The disclosed embodiments may be implemented as a component of a project management system or as a stand-alone system.

The disclosed methods and systems provide a quantitative estimation method of generating a consolidated quantitative estimate for a task comprising a plurality of defined sub-tasks. Each task is broken down into a plurality of sub-tasks, the task and sub-task data is stored in a system database or data file. In an embodiment the task and sub-task data is stored in a database accessible to the estimation engine via data communication, for example, via a wired or wireless private network (i.e. Ethernet LAN, WiFi WLAN or combination thereof) or communication network and the Internet.

For each one of the plurality of defined sub-tasks of a task, sub-task identifiers are retrieved from memory, for example using a database query, or extracted from a data file or lookup table etc. A displayed sub-task identifier can be a numeric, alphanumeric, text, an icon, image or any other suitable indication of the sub-task requiring a time estimate, and may provide access to data relevant to the sub-task, including, for example, descriptive content, available resources, time constraints, physical constraints and associated attributes about the sub-task and/or the task. The data relevant to the sub-task may be displayed in response to a user input such as clicking on an icon or button to expand a window or display additional data fields.

The user interface and display driver controls the formatting and rendering for display of the sub-task identifiers, so when displayed a user can input time estimate values. The formatting of data for display may include display of data entry fields or cells and instructions for time estimate value entry. The sub-task identifier can be presented in any form that allows a user, typically a responsible person for the sub-task, to recognise the sub-task and input time estimation data. The data defined for each subtask can include a task/sub-task allocation identifier indicating the team member or team to which the task/sub-task has been allocated. For example, using text, numeric, alphanumeric codes, icons, colours, images, maps etc. Effects such as zoom in and zoom out or expansion and collapsing of tasks and subtasks may also be used to allow visualisation of different levels of detail and granularity of tasks and task breakdown during the estimation process. The user interface and display driver can be configured to selectively render for display sub-tasks for a responsible person or based on allocated users for tasks. For example, subtasks for display may be grouped based on team or team member allocated to the sub-task and display of sub-task ordered by team and/or allocated team member, alternatively only tasks/sub-tasks allocated to a team or team member may be rendered on displays/terminals associated with the allocated team.

For each sub-task the estimation processor receives and stores in memory a data input indicating a value for one end of a range for the estimate and a data input indicating range width. In a first embodiment the first time value is a low end estimate for the sub-task and the second time value is a value indicating range width, for example a multiplier. In a second embodiment the first input is a high end time estimate for the sub-task and the second time value is a value indicating range width, for example a divisor. The second value may also be a width value. In a third embodiment the first time value is a low end estimate and the second time value is a high end estimate. In response to receiving input of the first time value and the second time value, the estimation processor calculates from the first time value and second time value for the sub-task a low end time value, a high end value, a range width value and a centre value. In the first embodiment described above the low end time value is multiplied by the multiplier to calculate the high end estimate time value. In the second embodiment described above the high end time value is divided by the divisor to calculate the low end time value. In the third embodiment the high end time value is divided by the low end time value to derive a multiplier indicative of the range width. For each of the embodiments the centre value, which may also be referred to as the standard estimate, can be calculated:

center value=(low end estimate+high end estimate)/2 [Eq. 2]

The steps to can be repeated until all subtasks for a task have been completed.

In response to having received and processed the first time value and second time value for all sub-tasks of the task, the estimation processor aggregates the centre value for each sub-task of a task to determine the consolidated quantitative estimate for the task, and outputs the consolidated quantitative estimate for the task. The estimate can also be stored in memory or a database. The consolidated estimate may be output to a user via a user interface. Alternatively or additionally the consolidated estimate can be output to one or more further project management or tracking system components, for example a resource scheduling tool. In some embodiments, data output to the project management and work tracking system can also include any one or more of the low end time estimate, high end time estimate, multiplier/range and centre value for sub-tasks. For example, the subtask estimate values output as a data file, data signal or stored in a database part of or accessible to the project management and work tracking system.

Alternative or additional consolidated estimates are contemplated within the scope of this discussion. For example, the data defined for each subtask can include an allocated user identifier the estimation processor is further configured to aggregate the centre value of each sub-task for an allocated user of one or more task to determine a consolidated estimate for the allocated user.

The above consolidated estimate generation can be repeated for a plurality of tasks, for example a group of tasks making up a body of work, and a further consolidated estimate generated for a plurality of tasks by aggregating the consolidated estimates for each task.

Consolidated estimates may also be prepared based on a team of allocated users or other task attributes, for example project critical path tasks, project phase, physical resource based task or subtask grouping etc.

Embodiments include the estimate range ends and width which are determined from two input subjective values. For example, in one embodiment one value indicates one end of an estimation range and the other value indicates the width of the range. The person responsible for making the estimation, the responsible person, can be instructed to choose the values to input as subjective low granularity estimates, that the responsible person has high confidence that the sub-task outcome can be achieved or delivered within the estimate range. For example, the first value may be a very optimistic estimate, which the user has a high confidence in being a “best case scenario” but not beyond feasibility for execution of the subtask, for example 85-90% confident that a better result will not be achieved. The other value indicative of the width may be indicative of the other end of the range, or a multiplier “n”, for example, based on the reasoning that after nominating an optimistic estimate value a pessimistic estimate may be n times the optimistic estimate. For example, 85-90% confident that a “worst case” would not be more than triple the time estimated for the “best case”. This estimate input request enables users to input an intuitive “guess” estimate range, using only 2 numbers, which requires little effort to come up with but the responsible person is reasonably certain and prepared to commit to an outcome being achieved somewhere within that range. This system acknowledges that estimation of work is typically inaccurate. Further, by providing an end point and range, or two end points, it is easier for a person to consider other factors which may affect their performance during the task duration, for example state of health, concurrent workload, reliance on external deliverables and other obligation/commitments that may impact on the task execution. Variables and unknowns can be accommodated in the estimation system simply by increasing the multiplier and hence range width.

It should be appreciated that the responsible person, may be an experienced project team making estimates for tasks for which they are responsible for delivering, tasks allocated to that user. The responsible person may also make estimates on behalf of other (typically less experienced or not yet allocated) team members. The responsible person may, in some circumstances, the responsible person may be a notional “responsible person” with the estimate in fact being provided and committed to by a project team. The two estimate values are input by a user, who may be the responsible person or may be another user inputting values with input or under instruction of the responsible person.

Embodiments of the methods and systems enable estimates to be made independent of an attempt to characterise or assume a probability distribution of outcomes. From historical and empirical evidence it has been observed that, typically for professional services and in particular software development, task outcome probabilities tend to show a positively skewed distribution (an example is shown in FIG. 4) with a longer tail on the right of the distribution, therefore estimation theories based around normal distributions is typically flawed. Further, the distribution can change from task to task and due to the unknowns for estimation of software projects the actual distribution cannot be predicted with any accuracy in the planning phase of a project.

The disclosed methods and the systems provide a simplified estimation method robust against varying probability distributions. Estimators which may be responsible persons are asked to make a low estimate (90% sure they cannot beat it), which compels one to consider an optimistic and probably lucky low number. Then apply a multiplier, which can be referred to as an “X factor” (a multiplication factor), from which a high end estimate can be derived. In one embodiment the system restricts the multiplier value to being an integer value. The reason an integer value is preferred for a multiplier is because prediction with better accuracy is unlikely without the benefit of hindsight. For example, it may be shown that a correct multiplier was 2.1 with the benefit of hindsight. However, when trying to make predictions humans do not estimate with accuracy. In invoking a predictive and subjective heuristic for coming up with a number, and the method does not suffer the side-effects of the illusion of accuracy and does not suffer from needing historical data. FIG. 4 is an example of a skewed probability distribution indicative of likely time taken for a software project task, the low end (LE) estimate, 85% to 90% confidence a better result would not be achieved, and high end (HE) estimate, 85% to 90% confident the work can be done by this time, are easier to predict and commit to achieving than the mean, median, mode, deviation and skew of the distribution.

An advantage of the disclosed embodiments is that the estimation for a task only requires two numbers, indicative of a range without making any commitment to a “most likely” outcome within that range or assumption of a particular statistical distribution.

Empirical test evidence shows that this estimation system does not seem to suffer as badly from human factors as known previously methods. The reason that it works is that it encourages a responsible person to simultaneously consider the optimistic and pessimistic outcome and give a rating, indicative of a degree of confidence they have in their number. If it is a tight skew, it will have a low multiplier. If it is a long skew, it will have a high multiplier. Thus, a qualitative assessment of the median is provided whilst also providing a qualitative assessment of the spread. So from two numbers, the disclosed systems and methods can determine the range endpoints and width. From these values a fourth value can be calculated, which is the average of the high and the low (the standard estimate). This centre value for sub-tasks is aggregated to provide the consolidated estimate for the task.

Additionally, from empirical test evidence illustrated in FIG. 5, it has been found that the standard estimate is likely to be slightly higher than the median and the mode. The empirical test evidence of the standard estimate provides a slightly more paranoid estimate, closer to the likely mean probability.

The applicant has found from test data that even for relatively small sample sizes, around 12-24 people, even though there may be high variety in optimism and pessimism between individual estimators, the aggregated consolidated estimate value has been shown to give a reasonable prediction of the task effort outcome. Test evidence indicates that projects that are estimated using the disclosed methods and systems have been shown to be much easier to bring in on time, than projects estimated using a statistical factor method. The problem with the three or four point statistical estimation methods is that people don't have the data to enable an accurate estimate, but the method provides an (unreliable) illusion of accuracy which can, in turn, lead to unrealistic expectations and frustration.

The disclosed estimation methods and systems starts from a presumption of inaccuracy and acknowledgement of subjectiveness of estimates. By asking for estimators to identify a range that they have high confidence of being able to achieve an outcome somewhere within that band, there is no requirement to specify any “most likely” outcome. The range or band is nominated based on either an optimistic or a pessimistic outcome estimate and an integer multiplier—indicative of variability of the work being estimated. Thus, the estimation values are input independent of any particular probability distribution shape or requirement to commit to any particular value within the band.

The width of the band can be indicative of how confident the estimator is to estimate the work. For example, a low value multiplier is a narrow band indicating low variability between the high and low estimates, whereas a sub-task with many unknowns may have a high multiplier value indicating low confidence in the ability to accurately estimate the required effort. By aggregating mid points of the bands for the consolidated estimates this assumes inaccuracies will “even out” in the end. This method has been found to produce much more commercially useable numbers than any other method the applicant has observed. Further the applicant has used retrospective data to identify estimators who are typically pessimistic and those who are typically optimistic and observed that there is a normalising effect. The optimists are happy to consider the low estimate and a “risky factor”, whereas the pessimists are happy to consider the high estimate and a “lucky factor”.

Further, empirical evidence has shown that network effects are typically accommodated within the estimates, as the estimates are subjective and estimators can instinctively adjust estimates based on anticipated parallel or serial tasks. For example, allowing extra time between optimistic and pessimistic estimates for tasks that are likely to be worked on in parallel or have some dependency.

Examples of estimation methods and systems have been discussed above with reference to project planning, work task scheduling and tracking which typically use time based estimates. However, the described estimation methods and systems may be employed for estimating values other than time, for example monetary values for professional services where deadlines may be fixed but costs dependent on the resources applied to the tasks. For example, planning deadline based services such as legal or contract services. In another example, for example for delivery or logistics planning estimates may be based on anticipated speed and distance, for example for sea or air freight enabling alternative routing and speed based on environmental factors to be accommodated for in a planning process. It should be appreciated that embodiments of the systems and methods described above may be utilised in a variety of planning and tracking systems.

The disclosed systems and methods can be retrofitted into current or existing scheduling systems making those systems more robust. Current or existing systems may have additional parameters providing computations specific to the industry in which they are applied. Utilising the same or different hardware, the disclosed systems and methods can enhance those systems as a retrofit, improving their results.

In a manufacturing environment or plant, where for example a customisation unit assembles products for specific orders, the products need to move through the manufacturing plant for assembly, and preferably do so in the most efficient and productive manner. Customisation is common, for example, in the computer industry where a buyer orders a computer with a customised specification. In preparing for delivery of that computer, the manufacturer will build the computer for the customer. Tasks for customisation may be without an established time history.

Customisation is common in many businesses and industries where a larger task including sub-tasks or different smaller tasks may be required on short notice and where a history of the time taken for one or more of the sub-tasks is not available. While this example is related to a high tech industry, the same would hold true of any industry. One can consider the same discussion for custom furniture building, framing, construction, landscaping, and so on that may have existing scheduling systems specific to their industries.

In a manufacturing environment, while tasks can be repetitive, their initial establishment can require the time estimation as described herein. The disclosed systems and methods, for example, may be used prior to establishing a history. The history may be found to be equal to the time estimate in accordance with the disclosed systems and methods.

Many different tasks may be involved in a manufacturing process. In the example of custom computer building, the task of building a computer to specification, the sub-tasks may include fetching a component, positioning the component into a computer casing, connecting the component to other components, securing the component within the casing, moving the computer to the next assembly station, and so on. For specific customised orders as described immediately above, different combinations of previously time estimated sub-tasks may be required so the aggregation of those time estimations can be provided by the systems and methods described herein. In this way, the disclosed methods and systems can be retrofitted into existing scheduling systems, changing an existing system to having the capability to build in time estimates and the aggregation in the manner that is described herein, and ultimately, providing a robust outcome for time estimation where history is unavailable.

It may be found in some circumstances that the step of establishing a time history is not necessary when a particular scheduling system is retrofitted with the disclosed time estimation systems and methods. The robustness of the disclosed systems and methods may replace the need to monitor time to establish a historical value. A transformation of an existing scheduling system with a retrofit of the disclosed time estimation systems and methods may eliminate the need for the step of establishing a time history and replacing that with the estimated time based upon the retrofitted system.

It will be understood to persons skilled in the art that many modifications may be made without departing from the spirit and scope of the invention. It should be appreciated that in the context of the present specification the terms “module” and “component” are used to refer to a system component implementing defined functionality. The system component can be implemented as a software program executable using a processor or as a software routine integrated into a software program providing additional functionality. The system component may be equally implemented using a combination of hardware and software. The disclosed embodiments may be implemented using any suitable combination of hardware, software and firmware, and may utilise a combination of shared and dedicated data processing hardware and memory resources. For example, a dedicated hardware circuit, such as an application specific integrated circuit (ASIC) for programmable logic such as a field programmable gate array (FPGA) or programmable logic controller (PLC), may be used to implement some system functionality. This hardware circuit may be used in a data processing system having at least one processor, memory and other resources for executing cooperating firmware and software to support the full functionality of the system and integrate with external systems such as user terminals. It should be appreciated that many alternative system architectures could be used to implement the system and all such alternatives are envisaged within the scope of the present application.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A work flow management method carried out on one or more computers for determining a measure of acceptability based upon one or more particular work flow management variants that are exhibited in work flow items of a set of work flow to determine a set attribute score corresponding to an acceptability band, comprising:
receiving input of work flow management variant values of the work flow items of the set of work flow items, the work flow management variant values providing at least one of a quantitative and qualitative evaluation indicative of one or more work flow management variants exhibited in the work flow items wherein work flow management variant values include quantitative time estimates;
determining the quantity of work flow items of the set of work flow items that satisfy one or more subset criteria, the subset criteria providing filtering values for filtering the work flow items, the subset criteria being based upon one or more work flow management variant values;
generating based on the work flow items that satisfy the subset criteria the set attribute score for the set of work flow items;
comparing the set attribute score to the acceptability band wherein predetermined acceptability and diminishing acceptability relative to the predetermined acceptability are determined as a plurality of quantifiable values for the set of work flow items;
from the comparison, generating as output one of the plurality of quantifiable values for the set of work flow items as a measure of the acceptability of the set of work flow items;
determining based at least in part upon the measure of the acceptability of the set of work flow items to release one or more work flow items to a work flow buffer of a resource; and
delivering to the resource the work flow items of the work flow buffer.

2. The method as claimed in claim 1 wherein the step of generating the set attribute score comprises aggregating the quantity of work flow items that satisfy the subset criteria.

3. The method of claim 1, further comprising:
determining whether adjustment to the set of work flow items should be made if the acceptability measure is not within particular work flow management parameters.

4. The method of claim 1, wherein the step of generating the set attribute score is based on at least one of the quantitative and qualitative evaluation indicative of one or more work flow management variants exhibited in the work flow items that satisfy the subset criteria.

5. (canceled)

6. The method of claim 1 wherein the output is utilised in a workflow management system to determine whether certain work items are to be placed in a workflow buffer.

7. The method of claim 1, wherein the quantitative time estimates are established according to input of a responsible person of a low end time value estimate and an x-factor which is a multiplier value of the first time estimate value.

8. A method for configuring an acceptability band, comprising:
determining at least one work flow management variant that is exhibited in a set of work flow items;
providing a criteria filter based upon one or more criterion to be applied to the set of work flow items to determine a set attribute score based upon a subset of work flow items that satisfy criteria of the criteria filter;
establishing an acceptability band having acceptability levels to measure acceptability based upon one or more particular work flow management variants that are exhibited in work flow items of the set of work flow items to correspond to the set attribute score; and
establishing a correlation of the set attribute score to one or more levels of the acceptability band to provide output of the acceptability band.

9. (canceled)

10. The method of claim 7 wherein the output is utilised in a workflow management system to determine whether certain work items are to be placed in a workflow buffer.

11. A method carried out on one or more computers for determining a measure of acceptability based upon one or more particular work flow management variants that are exhibited in work flow items of a set of work flow items to determine a set attribute score corresponding to an acceptability band, comprising:
receiving input of work flow management variant values of the work flow items of the set of work flow items, the work flow management variant values providing at least one of a quantitative and qualitative evaluation indicative of one or more work flow management variants exhibited in the work flow items;
determining the quantity of work flow items of the set of work flow items that satisfy one or more subset criteria, the subset criteria providing filtering values for filtering the work flow items, the subset criteria being based upon one or more work flow management variant values;
generating based on the work flow items that satisfy the subset criteria the set attribute score for the set of work flow items;
comparing the set attribute score to the acceptability band wherein predetermined acceptability and diminishing acceptability relative to the predetermined acceptability are determined as a plurality of quantifiable values for the set of work flow items; and
from the comparison, generating as output one of the plurality of quantifiable values for the set of work flow items as a measure of the acceptability of the set of work flow items.

12. The method of claim 11 wherein work flow management variant values include quantitative time estimates established according to input of a responsible person of a low end time value estimate and an x-factor which is a multiplier value of the first time estimate value.

13.-15. (canceled)

16. The method of claim 11 wherein the step of generating the set attribute score further comprises determining a quantitative value for the work flow items that satisfy the subset criteria relative to a the total set.

17. A The method of claim 11 wherein the acceptability band defines two or more contiguous ranges for comparison with the set attribute score and each range is associated with one or the plurality of quantifiable values.

18. The method of claim 17 wherein the contiguous ranges radiate from a target range representing the predetermined acceptability and the acceptability of each range diminishes based on increasing distance from the target range.

19. The method of claim 11 wherein a target proportionate mix for two or more measures of acceptability is defined for the set of work flow items, and the method further comprises the step of:
determining the set attribute score and quantifiable value for the set of work flow items for each of the measures of acceptability for the target proportionate mix;
processing the set attribute scores and quantifiable values for the measures of acceptability to determine the relative proportional values for the two or more measures of acceptability for the set of work flow items,
comparing the relative proportional values with the target proportionate mix for the set of work flow items, and
outputting of the comparison result.

20. The method of claim 19 wherein the desired proportional mix is defined based on a subset of a set of a plurality of measures of acceptability determinable for the set of work flow items.

21. A system for determining a measure of acceptability based upon one or more particular work flow management variants that are exhibited in work flow items of a set of work flow items to determine a set attribute score corresponding to an acceptability band, the system comprising a data store and a processor,
the processor being configured to:
receive and store in the data store, input work flow management variant values of the work flow items of the set of work flow items, the work flow management variant values providing at least one of a quantitative and qualitative evaluation indicative of one or more work flow management variants exhibited in the work flow items;
determine the quantity of work flow items of the set of work flow items that satisfy one or more subset criteria, the subset criteria providing filtering values for filtering the work flow items, the subset criteria being based upon one or more work flow management variant values;
generate based on the quantity of work flow items that satisfy the subset criteria the set attribute score for the set of work flow items;
compare the set attribute score to the acceptability band, stored in the data store, wherein predetermined acceptability and diminishing acceptability relative to the predetermined acceptability are determined as a plurality of quantifiable values for the set of work flow items; and
from the comparison, generate as output one of the plurality of quantifiable values for the set of work flow items as a measure of the acceptability of the set of work flow items.

22.-27. (canceled)

28. The system of claim 21 wherein desired target proportionate mix for two or more measures of acceptability is defined for a set of work flow items, and
the processor is further configured to determine the set attribute score and quantifiable value for the set of workflow items for each of the measures of acceptability for the target proportionate mix and process the set attribute scores and quantifiable values for the measure of acceptability to determine the relative proportional values for the two or more measures of acceptability for the set, compare the relative proportional values with the target proportionate mix for the set of work flow items and output the comparison result.

29. The system of claim 28 wherein the desired proportional mix is defined based on a subset of a set of a plurality of measures of acceptability determinable for the set of work flow items.
